(19) United States
(12) Patent Application Publication
(10) Pub. No.: US 2021/0383719 A1
(43) Pub. Date: Dec. 9, 2021

(54) DEVICES SYSTEMS AND METHODS TO DEVELOP INFANT HAND-EYE COORDINATION AND SPATIAL AWARENESS WHILE INTERACTING WITH A CARETAKER

(71) Applicant: James David Busch, (US)

(72) Inventor: James David Busch, Tempe, AZ (US)

(21) Appl. No.: 17/339,914

(22) Filed: Jun. 4, 2021

Related U.S. Application Data
(60) Provisional application No. 63/035,541, filed on Jun. 5, 2020.

(51) Int. Cl. G09B 19/00; G09B 9/00

(52) U.S. Cl. CPC G09B 19/003; G09B 9/00

(57) ABSTRACT

An infant development device or toy including a body configured to be held by an adult, and a directional input manipulated by an infant. The device or toy performs various functions in response to different directional input provided by the infant. For example, the toy may provide audio output corresponding with the directional input and/or visual output on a display device corresponding with the directional input. The toy may also include one or more additional input devices designed to be manipulated by the adult to provide positive reinforcement or corrective prompts to the infant. To use the toy, the adult carries the infant while holding the toy in one hand. The adult then walks the infant in the direction (forward, backward, turn right, turn left, etc.) indicated by the toy in response to the infant's manipulation of the directional input device. Other variations and uses for the device are contemplated.

### CROSS REFERENCE TO RELATED APPLICATIONS

This application claims the benefit of U.S. Provisional Application 63/035,541, filed Jun. 5, 2020, which is herein incorporated by reference in its entirety.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### REFERENCE TO A COMPUTER PROGRAM

The Computer Program Listings titled “Code Table 1,” “Code Table 2,” “Code Table 3,” and “Code Table 4,” provided in U.S. Provisional Application 63/035,541, filed Jun. 5, 2020, are hereby incorporated by reference in its entirety for all purposes.

### BACKGROUND

### 1. Field of the Invention

The present disclosure generally relates to devices, systems, and methods to enhance and/or accelerate the development of hand eye coordination, spatial awareness skills of an infant as early as about two months old while interacting with a caretaker.

According to in industry publications:

Spatial awareness is a complex cognitive skill that tells us our position relative to obj ects around us, and the relative position of objects to each other. It involves understanding the concepts of direction, distance, and location, and it's at the heart of learning and performing countless tasks.”

By the time [your child] is 18 months old, your child has a basic understanding of spatial concepts. This is built on answers to the following questions, which he's been learning since the day he was born . . . .

Where am I in space?

The vestibular system uses information from fluid in the inner ear to tell us where we are in relation to gravity (standing vs. lying, for instance), whether we are moving or still and, if we're moving, at what speed and in what direction.

How do I get around safely, efficiently, and effectively?

Often referred to as motor planning, this skill develops through trial and error as a baby explores his environment and learns how to navigate it. A new walker bumps into the coffee table until he learns how to walk around it. A toddler learns to sequence the steps involved in safely jumping from a low step to the ground.

What do concepts of direction, distance, and location mean?

Imagine what a baby learns when he reaches for a toy: Where is the toy? How do I position my body to reach for it? How far do I have to reach to grasp it? As he gets of der, he learns spatial concepts like behind, above, beside, and under from interacting with parents and caregivers during play.

You can support your little one's spatial awareness by nurturing all of the above areas of development, and by playing games that teach him spatial concepts of direction, distance, and location.

BabySparks, “What is Spatial Awareness and How Does it Develop?”, BabySparks (Feb. 20, 2019) (Cite No. D008).

It is commonly stated that infants develop spatial awareness by 18 months of age. This is largely due to the conventional thought process that the infant must first be able to crawl before they can develop spatial awareness; and spatial awareness leads to logical thinking. For example, according to Parents.com:

When babies are older and can crawl after the ball, they are working on spatial awareness—How far away is that ball? Where is my body in relation to it? As toddlers become preschoolers, spatial awareness leads to logical thinking. Now that they're getting the hang of throwing and catching, they have to start figuring out how hard to throw and in which direction. In other words, they have to estimate the parameters in which they can throw and catch.

Moira Moderelli, “3 Best Toys for Intellectual Development,” Parents.com (retrieved on Jun. 4, 2020) (Cite No. D062).

Many of the ways that spatial awareness is developed requires the infant to be mobile, which experts and industry articles assume means crawl. For example, according to KinderCare, some of the ways to allow a crawling or walking child to develop spatial awareness are:

1. Give Your Baby Freedom to Explore

Highchairs and cribs have their place, but babies also need plenty of time (and a safe place) to crawl around and explore their environment. A little exploration helps him figure out where he is in relation to the objects around him and learn concepts like near, far, high, and low.

2. Play Hide-and-Seek Games

Finding a good hiding spot is perfect for developing spatial awareness (and kids love it!). For younger children, you can make the game easier by hiding a stuffed animal or a favorite toy. (Fair warning: Young children will ask to play this over and over and over again!)

6. Play Spatial Sports

Soccer, baseball, gymnastics, and dance are all great choices (and even better, these activities keep kids active and healthy). Not only will he have a ball, but things like adjusting his bat to the different positions of a pitched baseball, learning that standing too close on the dance floor means a run-in with someone, or discovering just how hard to kick the soccer ball to make a goal will help him gain valuable spatial-awareness skills!

Cheryl Flanders, “The Mind-Body Connection! 6 Activities to Help Kids Build Spatial Awareness,” KinderCare (retrieved on Jun. 4, 2020) (Cite No. D063).

Industry articles acknowledge that there is a “Catch-22” situation. Infant's lack of control over their limbs prevents them from discovering information that can be used to improve limb control. Specifically, in David I. Anderson, “Motor Development: Far More Than Just the Development of Motor Skills,” (Cite No. D065) this “Catch-22” problem is discussed:

In one influential paper, Corbetta and Snapp-Childs's (2009) analysis of changes in reach-ing, grasping, and object manipulation in 6- to 9-month-olds after repeated exposures to different objects revealed the counterintuitive finding that tensions between perception and action complicated the development of perceptual-motor mapping. Specifically, younger infants had difficulty mapping the visual information used during reaching, grasping, and manipulation with the haptic infor-mation available during grasping and manipulation because of limitations in the ability to control the upper limb. The irony here is that control of movement patterns improves as the child discovers the sources of information that can contribute to such improvements; however, discovery and utilization of those sources of information appeared to be impeded by the strong intrinsic dynamics of the infants' upper limb movements. In other words, lack of control over the limb impeded the process of discovering the sources of information that could be used to improve limb control—a classic catch-22 situation.

Pangelinan et al. found expected relations between IQ and the volume of global gray matter, as well as the volume of frontal and parietal gray matter and parietal white matter. Most interesting, however, was the significant positive relation found between IQ and the volume of the cerebellum and caudate, two subcortical brain structures once thought to be exclusively involved in motor functions. The volume of the putamen, another subcortical structure once thought to be exclusively involved in motor func-tion, was also significantly and positively related to spatial working memory.

(See Cite No. D065)

Using the devices systems and methods disclosed herein, it is possible to unlock mobility for a child starting at 2 to 3 months of age. This accelerates the development of hand eye coordination and spatial awareness from a much younger age, well before an infant is able to move on his or her own by crawling or walking. The devices systems and methods herein are believed to remedy the Catch-22 situation because the infant is able to access sources of information that can be used to improve limb control without needing much limb control in the first instance.

The ability to accelerate this development uses unconventional devices, systems and methods whereby the infant is provided with the ability to express his or her desire to move around, and in response to the expressed desire is allowed to move and explore before they are able to on their own. As a result, it is believed that the infant may start practicing logical thinking earlier in life.

For example, based on experimentation with a 2-4 month old using the devices systems and methods disclosed herein, it was found that the infant was able to navigate around a home to find his mother, explore a basket of toys that he was unfamiliar with, and express a desire for a diaper change by navigating to his changing station. At 4 months old, the infant was skillful and proficient at navigating the house to go to his changing station when he needed a change, his bottle station when he wanted food, and exploring the pantry. He also developed games he played with his mother where he would go to his mother then back away laughing once he got attention. At 12 months, the infant was able to walk on his own and navigate the house. The infant would go to rooms or items of interest to him by name when asked to (e.g., the kitchen, his crib, the bath, his play area, the oven/toaster/refrigerator, etc.). At 15 months, the infant requests to use the devices systems and methods herein by grabbing the device and bringing the harness to a parent, then he uses the devices to access high up items like light switches, the refrigerator handle, or doorknobs to access restricted areas such as the garage.

All of this occurred with this infant well before 18 months indicated for the beginning of developing spatial awareness based on crawling and walking alone.

### 2. Description of Related Materials

So as to reduce the complexity and length of the Detailed Specification, and to fully establish the state of the art in certain areas of technology, Applicant(s) herein expressly incorporate(s) by reference all of the following materials identified in each paragraph below and any other references or patent documents found in the text of this Application.

The Cite Numbers referred to herein are set forth in the Information Disclosure Statement (IDS) filed contemporaneously with this application and incorporated by reference herein.

The related art shows the novel and non-obvious nature of the present invention including secondary considerations of non-obviousness such as the long-felt need and failure of others to achieve the present invention. All referenced materials are herein incorporated by reference in its entirety.

The devices, systems and methods disclosed herein may incorporate a number of components.

For more information on user input devices, see, for example:
“Input Device,” Wikipedia (retrieved on Jun. 1, 2020) (Cite No. D001).
“Joystick,” Wikipedia (retrieved on Jun. 1, 2020) (Cite No. D002).
“Potentiometer,” Wikipedia (retrieved on Jun. 1, 2020) (Cite No. D003).
“D-Pad,” Wikipedia (retrieved on Jun. 1, 2020) (Cite No. D004).
“Category: Switches,” Wikipedia (retrieved on Jun. 1, 2020) (Cite No. D005).
“Category:Input/output,” Wikipedia (retrieved on Jun. 1, 2020) (Cite No. D006).
“Joystick hat.ino,” M5Stack (retrieved on May 20, 2020) (Cite No. D007)
“Mini Dual Button Unit,” M5Stack (retrieved on May 20, 2020) (Cite No. D030).
“I2C Joystick Unit,” M5Stack (retrieved on May 20, 2020) (Cite No. D031).

For more information on display devices, see, for example:
“Category:Display devices,” Wikipedia (retrieved on Jun. 1, 2020) (Cite No. D009).
“Display device,” Wikipedia (retrieved on Jun. 1, 2020) (Cite No. D010).
“Liquid-crystal display,” Wikipedia (retrieved on Jun. 1, 2020) (Cite No. D011).
“OLED,” Wikipedia (retrieved on Jun. 1, 2020) (Cite No. D012).
“AMOLED,” Wikipedia (retrieved on Jun. 1, 2020) (Cite No. D013).
“Light-emitting diode,” Wikipedia (retrieved on Jun. 1, 2020) (Cite No. D014).
An overlay (e.g., sticker, molding, diffusing device, label, etc.) may be placed over LED lights to help remind a user of the meaning of different LED elements when they illuminate.
“Charlieplexing,” Wikipedia (retrieved on May 26, 2020) (Cite No. D029).

For more information on audio devices, see, for example:
“Category:Computing output devices,” Wikipedia (retrieved on Jun. 1, 2020) (Cite No. D015).
“Category:Loudspeakers,” Wikipedia (retrieved on Jun. 1, 2020) (Cite No. D016).
“Piezoelectric speaker,” Wikipedia (retrieved on Jun. 1, 2020) (Cite No. D017).
“Buzzer,” Wikipedia (retrieved on Jun. 1, 2020) (Cite No. D018).
“M5StickC Speaker Hat (retrieved on May 20, 2020) (Cite No. D019)

For more information on various forms of circuitry, see, for example:
“Category: Analog circuits,” Wikipedia (retrieved on Jun. 1, 2020) (Cite No. D020).
“Category:Digital electronics,” Wikipedia (retrieved on Jun. 1, 2020) (Cite No. D021).
“Category:Digital circuits,” Wikipedia (retrieved on Jun. 1, 2020) (Cite No. D022).
“Category:Microcontrollers,” Wikipedia (retrieved on Jun. 1, 2020) (Cite No. D023).
“AVR microcontrollers,” Wikipedia (retrieved on Jun. 1, 2020) (Cite No. D024).
“Arduino,” Wikipedia (retrieved on Jun. 1, 2020) (Cite No. D025).
“ATmega238,” Wikipedia (retrieved on Jun. 1, 2020) (Cite No. D026).
“ESP32,” Wikipedia (retrieved on Jun. 1, 2020) (Cite No. D027).
“AM4EC Series Data Sheet Rev 1.6,” Alpha Microelectronics Corp. (Jul. 1, 2004) (Cite No. D028).
“M5StickC ESP32-PICO Mini IoT Development Kit,” M5Stack (retrieved on May 20, 2020) (Cite No. D033).
“LilyGo TTGO-TS-V1.4 V1.2 V1.0,” LilyGO on Github, (retrieved on May 31, 2020) (Cite No. D034).
“SimpleLink™ Bluetooth low energy Multi-standard SensorTag,” Texas Instruments (retrieved on Jun. 1, 2020) (Cite No. D064).

For more information on various batteries and electrical power sources, see, for example:
“Electric battery,” Wikipedia (retrieved on Jun. 1, 2020) (Cite No. D035).
“AA battery,” Wikipedia (retrieved on Jun. 1, 2020) (Cite No. D036).
“AAA battery,” Wikipedia (retrieved on Jun. 1, 2020) (Cite No. D037).
“List of battery sizes,” Wikipedia (retrieved on Jun. 1, 2020) (Cite No. D038). (e.g., 18650, etc.)
“AC adapter,” Wikipedia (retrieved on Jun. 1, 2020) (Cite No. D039).

For more information on communication interfaces, see, for example:
“Category:Serial buses,” Wikipedia (retrieved on Jun. 1, 2020) (Cite No. D040).
“Category:USB,” Wikipedia (retrieved on Jun. 1, 2020) (Cite No. D041).
“Bluetooth,” Wikipedia (retrieved on Jun. 1, 2020) (Cite No. D042).
“WiFi,” Wikipedia (retrieved on Jun. 1, 2020) (Cite No. D043).
“Category:Wireless communication systems,” Wikipedia (retrieved on Jun. 1, 2020) (Cite No. D044).
“1 to 3 Grove Hub Unit,” M5 Stack (retrieved on May 20, 2020) (Cite No. D032).

For more information on vibration/haptic feedback/other user interface technologies, see, for example:
“Haptic technology,” Wikipedia (retrieved on Jun. 1, 2020) (Cite No. D045). (e.g., a vibration motor, etc.)

For more information on sensors, see, for example:
“Inertial measurement unit,” Wikipedia (retrieved on Jun. 1, 2020) (Cite No. D046).
“Accelerometer,” Wikipedia (retrieved on Jun. 1, 2020) (Cite No. D047).
“Gyroscope,” Wikipedia (retrieved on Jun. 1, 2020) (Cite No. D048).
“Magnetometer,” Wikipedia (retrieved on Jun. 1, 2020) (Cite No. D049).
“Sensor,” Wikipedia (retrieved on Jun. 1, 2020) (Cite No. D050).
“Category: Sensors,” Wikipedia (retrieved on Jun. 1, 2020) (Cite No. D051).
“List of sensors,” Wikipedia (retrieved on Jun. 1, 2020) (Cite No. D052).
“Category:Transducers,” Wikipedi a (retrieved on Jun. 1, 2020) (Cite No. D053).

For more information on other developmental toys for babies, see, for example:
“Vtech V. Smile TV Learning System User's Manual,” Vtech (2007) (Cite No. D054).
U.S. Pat. No. 9,498,736, titled “Development apparatus” (Inventor; Marcia L. Haunt)

(Issued Nov 22, 2016). (Cite No. A001).
Meagan Meehan, “Interview with Marcia Haut, the founder of SmartNoggin Toys,”

Entertainment Vine (Oct. 7, 2017) (Cite No. D055).
“Laugh & Learn Game & Learn Controller,” Fisher Price (Cite No. D056).
“Battery Operated Baby Controller Musical Toy With Light And Music,” Alibaba (retrieved on May 26, 2020) (Cite No. D057).

For more information on early childhood education and development, see, for example:
“Early childhood education,” Wikipedia (retrieved on Jun. 1, 2020) (Cite No. D058).
“Kolb's experiential learning,” Wikipedia (retrieved on Jun. 1, 2020) (Cite No. D059).
“Constructivism (philosophy of education),” Wikipedia (retrieved on Jun. 1, 2020) (Cite No. D060).
“Child developmental stages,” Wikipedia (retrieved on Jun. 1, 2020) (Cite No. D061).
Moira Moderelli, “3 Best Toys for Intellectual Development,” Parents.com (retrieved on Jun. 4, 2020) (Cite No. D062).
Cheryl Flanders, “The Mind-Body Connection! 6 Activities to Help Kids Build Spatial Awareness,” KinderCare (retrieved on Jun. 4, 2020) (Cite No. D063).
David I. Anderson, “Motor Development: Far More Than Just the Development of Motor Skills,” Kinesiology Review, 2018, 7, 99-114 (available at https://doi.org/10.1123/kr.2018-0011) (Cite No. D065).
Jill C. Heathcock and James C. (Cole) Galloway, “Exploring Objects With Feet Advances Movement in Infants Born Preterm: A Randomized Controlled Trial,” PHYS THER. 2009; 89:1027-1038 Originally published online Aug. 27, 2009 doi: 10.2522/ptj .20080278 (Cite No. D066).
Heather A. Feldner, Samuel W. Logan & James C. Galloway (2016) Why the time is right for a radical paradigm shift in early powered mobility: the role of powered mobility technology devices, policy and stakeholders, Disability and Rehabilitation: Assistive Technology, 11:2, 89-102, DOI: 10.3109/17483107.2015.1079651 https://doi.org/10.3109/17483107.2015.1079651 (CiteNo. D067).

In addition, the following documents provide additional background:
U.S. Pre-Grant Publication No. 20110003274 titled “Educational System for Directionality Enhancement” (Cite No. B001).
U.S. Pat. No. 5,751,273 titled “Game controller for infants” (Cite No. A002).
U.S. Pat. No. 9,738,269 titled “Hand-held communicator for patient use” (Cite No A003).

Finally, searches were performed on PATFT and APPFT:
“CPCL/A63H and spec/joystick”,
“CPCL/A63H and spec/joystick and (spec/infant or spec/baby)”,
“spec/toy and spec/joystick and (spec/infant or spec/baby)”,
“(an/mattel or an/(\”fisher price\“) or aanm/mattel or aanm/(\“fisher price\”) and spec/joystick”,

A deep neural network semantic comparison algorithm was used to compare the text of each claim element of the draft claim 1 in this provisional application to each specification paragraph of the documents resulting from the above search. The deep neural network algorithm then ranked the non-duplicative results from the above searches according to a measure of relevancy with the draft claim. The ranked results are, in descending order of purported relevance:

5868600, 20200019157, 8614668, 8760398, 8847887, 8736548, 8909370, 8571781, 10012985, 8751063, 9114838, 9150263, 9193404, 9290220, 9389612, 9394016, 9395725, 9766620, 9836046, 9841758, 9952590, 20090055019, 20160282871, 20180224845, 20140020964, 20120173050, 20160004253, 20160033967, 20180113449, 20160202696, 20120168240, 20120168241, 20140236393, 20070072662, 20160291591, 20120173047, 7731588, 20180117480, 20120173049, 20180200618, 20150362919, 20150370257, 7204455, 20120173048, 20090017714, 20040195436, 7843429, 8068095, 7528835, 20070070072, 20180326315, 8579671, 20130179034, 10179508, 20120040755, 20060113428, 7668626, 20130249791, 8235826, 20140030955, 7628671, 20130169527, 9028312, 9586138, 9620004, 9753540, 20040195767, 20150321094, 20110059798, 20190247050, 7042440, 8111239, 8405604, 6720949, 10065693, 20050153624, 7291054, 20160071407, 10317898, 10620624, 7568963, 8425273, 9275517, 9607475, 9830778, 6415439, 6155835, 20040153211, 20060202953, 8090488, 20180039271, 9245428, 8545283, 20080122786, 7794303, 7139642, 20180071621, 20120229660, 20090132124, 20190287387, 7829778, 20190329402, 10521466, 20140163664, 20090325459, 20060033713, 8019223, 7548697, 20130267318, 20180353871, 20170305261, 6773344, 20170357716, 20090209170, 20060223637, 20080246215, 20070097832, 9990859, 20020036617, 4767334, 20110148041, 20120040587, 20080063400, 20090232506, 20180276197, 6053878, 20180047395, 10354011, 20040147202, 20040082268, 20170357637, 20040046736, 8500509, 8647166, 20080307945, 20060271251, 20190038991, 6462498, 20130278398, 9625905, 20150129669, 20140035736, 20160098085, 20170351331, 10185348, 20150217204, 20160334785, 20020163905, 7789180, 20090071137, 8740665, 9522726, 10607609, 20150309594, 20140220520, 10272349, 7758424, 20170008580, 20170158270, 8374724, 20080153382, 20160243455, 10035070, 20090197658, 20180065054, 8257157, 6886139, 9457281, 20190233035, 10569183, 20180104607, 20170199521, 20200129852, 8924044, 9397782, 9864370, 9804595, 8613639, 8944876, 9072979, 9155973, 20190113947, 20130217487, 20020089297, 20150147976, 20170003680, 8220260, 9120027, 9310904, 20130122775, 20140076221, 20140179193, 20170128851, 20170206805, 6907029, 20160184722, 20110189920, 20130084768, 20140323010, 9550129, 20150278263, 20150127341, 20170038763, 20150057841, 20140362210, 20170217016, 20130041671, 20020142701, 7853645, 10460085, 20170326725, 20140221088, 20180236360, 20110009175, 7297061, 10518173, 20100131078, 20030104756, 20100131080, 7162230, 8764510, 20130143482, 20040144582, 20190130780, 20140187320, 20030211832, 20180164803, 20190155273, 20090132441, 10086302, 9126122, 20140011428, 10384142, 20200132832, 20170189803, 7172196, 20060073760, 20140179432, 9650155, 9112619, 8287326, 20150253770, 10514689, 5127658, 20020108796, 20180107208, 20200159210, 20200129874, 10453333, 8600432, 9144748, 9589458, 9965948, 20100125366, 20060224280, 20120015686, 20140057678, 9486712, 4654659, 20190148025, 20120009845, 8591302, 10112295, 9704390, 9789604, 20160012719, 20170178495, 20180210485, 9043047, 9625903, 20140374541, 20170192420, 20030063135, 8641472, 20140162528, 6726523, 6971942, 20180361263, 10245521, 20150328554, 20150336017, 20160175723, 9795867, 20060251407, 7391320, 8049600, 8330583, 20170232358, 20120295510, 20090222149, 20120330481, 20150238854, 20160038848, 20130130585, 20090068925, 8468460, 6071166, 8636558, 20180093181, 8214098, 6742188, 20100178982, 20110003640, 20110065351, 20110287690, 8939842, 20190038969, 20140342321, 4246452, 20200089956, 10561950, 20090063628, 20150147936, 9770651, 20100144239, 20170291114, 20110034251, 5638053, 9269511, 20050114444, 20090082686, 20090157807, 20140002582, 10311529, 20130304806, 20180256989, 10369487, 8616973, 7578505, 20170031357, 8517788, 20030030441, 20010032278, 20120089275, 20160144283, 10434431, 9563202, 9658617, 20120058705, 20130244531, 10300372, 20170173485, 5125843, 20170031391, 8371893, 20040077284, 10315107, 6260862, 9233314, 20110301957, 20080180272, 9791897, 9919233, 10596478, 9579586, 9612627, 9656168, 9782684, 9324244, 20140121008, 20170146997, 20140002580, 20140249697, 20180185763, 20070021031, 20140337112, 20170173262, 20090030977, 20150196839, 20170144079, 20110060988, 8562387, 20100197411, 9039532, 20020161586, 9704491, 9421474, 20120027049, 20140002581, 20170028308, 20170032570, 20150243286, 20140297067, 20170248968, 10307667, 9004973, 9682316, 20150238869, 8958928, 20170228026, 20180028931, 20160375354, 4269596, 20150133205, 7819719, 20120005268, 20100167623, 10160538, 10196138, 9057273, 9284040, 9630703, 20160029963, 20140099853, 20150273351, 20180008891, 20170144069, 20070021032, 8062090, 20110221692, 8845386, 10610792, 20130190090, 9901832, 10276054, 20160016654, 20160200418, 20170217578, 20180327087, 20190176978, 20170336785, 7793890, 20070060350, 20140356174, 20150312336, 20120035799, 20040219861, 20060226298, 9597606, 8303364, 20090264205, 20160325180, 20150375134, 20080132332, 8874282, 9233315, 20080284613, 20130084765, 4660033, 20200043356, 20170173451, 20200001188, 20140057522, 20190217216, 6159101, 10394233, 20180043952, 10537821, 20120196507, 20030197092, 7497759, 20050064936, 7238079, 20130057594, 20190242482, 20010024973, 20150224400, 9962615, 6290565, 10143918, 7243053, 10258888, 10399616, 20160342162, 20150298788, 20160096614, 20160152316, 20170096210, 20170144741, 9959962, 20130157244, 9675888, 9128661, 20140263823, 20160023744, 9206309, 9315663, 10207315, 9551998, 10143919, 20150065258, 20190134501, 8083588, 8287374, 6286786, 6145789, 20090197499, 6257525, 20110221758, 20130296058, 20160082502, 20170219106, 6435875, 20190363590, 20180021675, 20130106586, 20130324250, 10245520, 20110189440, 20150321089, 20090162814, 20130338267, 10571931, 9518821, 20190055741, 7785098, 7893413, 8049193, 20170200544, 20180043838, 8882560, 10095226, 20090104956, 10022624, 10369463, 8475275, 8814688, 9039533, 9393500, 9770652, 9649565, 20130137336, 9067145, 7794302, 10248117, 8649918, 10046844, 8931730, 9242714, 9242729, 9284052, 9493225, 9884681, 20200004235, 6456977, 8200375, 8380368, 9079116, 9568913, 20180229796, 20140350750, 20150241877, 20170364067, 20190004511, 10078329, 9056667, 9753457, 8290019, 20150151208, 20150251102, 9927235, 20150011315, 20140282033, 8690670, 20130196770, 20140357373, 20150251100, 20170014714, 10336469, 20180099230, 20090086792, 8333592, 20180154271, 20100137066, 20150253771, 7614931, 8162716, 20090204276, 20130096736, 20140207311, 20120245764, 10357709, 20200001176, 4591158, 10295069, 9665099, 20140136019, 20120258802, 20140011589, 20140342344, 6688936, 20160029962, 10556188, 9884260, 20150099419, 20180015364, 20180339226, 6568983, 6692329, 20160030848, 20160144288, 10188958, 20080220692, 20180239410, 20130234634, 7704119, 5433669, 8905815, 20080125002, 20130172060, 10486078, 20090283629, 20030220723, 20040198168, 20130079141, 10377484, 20180093781, 20190138785, 20100001923, 9166506, 20080224575, 20140266025, 20170110903, 20020142699, 6520824, 20200045284, 20060154726, 5971320, 20140256446, 20160067600, 20120059730, 10637300, 9559544, 20170206561, 20180095492, 20180095461, 7878905, 7896742, 8330284, 8491389, 8531050, 8686579, 9138650, 20110300941, 9529358, 10286330, 10661191, 20110263330, 20170102698, 20080174448, 20170173483, 20080014835, 20050073276, 20160250535, 10011016, 20190121354, 9646328, 5314371, 20100056015, 7402964, 20200117197, 9360846, 6364040, 6478314, 10132490, 20080070474, 20180093171, 20140342834, 20150375129, 8025551, 4717364, 10477175, 20180207541, 20180140960, 9738382, 20180027222, 20070104036, 20010045978, 5158492, 20100003886, 4143307, 20060162464, 20050186884, 7563975, 20190184288, 4964598, 20190113975, 20170304732, 6966807, 8874444, 10650222, 20100081357, 7255618, 8283012, 8376805, 20050118903, 20060160442, 20100274902, 20140312824, 5100138, 7502759, 9155961, 9919232, 20030190856, 20030043268, 6652382, 6095268, 10213692, 20090281681, 20030037075, 8615471, 20130244536, 8335597, 20080032790, 4938483, 7261613, 10238962, 8939812, 20150301528, 20200023269, 20130102225, 20170182407, 5692956, 4729750, 20190258239, 8280827, 7591703, 20100062819, 20160008709, 20100021673, 20100023148, 10397527, 20180036876, 8702466, 20120187238, 20130226588, 20180071909, 20060121820, 20120215355, 20150202769, 20200152079, 8645230, 20170010607, 20060148374, 20130109267, 20020022507, 6317714, 20020171382, 20090005167, 7056124, 8086166, 20120045964, 20140129394, 20080064461, 20200054474, 8540547, 10611019, 8308137, 4251920, 6804511, 20160132052, 7193384, 9020639, 9320980, 20050235899, 9902058, 20120029695, 5433400, 20160297522, 20080207084, 10223438, 20120239513, 7330776, 8014897, 8504200, 9757855, 6364771, 20160121232, 20080220687, 20060183098, 10086641, 20130013478, 20060293102, 5628620, 7244183, 9709983, 7895779, 20090118012, 20100248840, 20120108339, 20140125009, 20150190711, 6674259, 7463001, 20080132343, 20080100250, 20090170395, 9011250, 9630100, 20190189030, 20150339756, 4541814, 20070270074, 6445150, 6696805, 7775893, 20140273715, 20070250110, 20040082269, 20200019930, 20140100037, 20150283459, 20160228764, 20180008890, 20170270324, 20190236681, 7731191, 8091892, 8628085, 8894066, 6527612, 6786731, 20080220864, 10204530, 20150174501, 8447439, 7320643, 8079901, 20100159798, 20120252309, 20150133023, 10325304, 20180229135, 8210895, 8556676, 9566520, 20140194029, 20020061710, 20080261483, 9939810, 8382567, 9747475, 6612893, 5906476, 20100325781, 20030040247, 20180290067, 6491566, 20120245761, 20060027482, 20020137427, 20150133217, 20120058706, 7086922, 20120068004, 20130024211, 9776097, 8322648, 20160354702, 5683298, 20050080666, 9827998, 9192874, 20180309786, 6857930, 9120025, 20140267189, 8686269, 20190042530, 20130107507, 8113905, 8500507, 20120321472, 20070232374, 20070234885, 20090082078, 20110059672, 20110143628, 7459624, 20200016501, 8003872, 20100262464, 8272917, 10585846, 20140235133, 20060189393, 20070176363, 20040084842, 5602553, 20060149415, 20070114108, 7485025, 7201374, 7017911, 20090035735, 20150314328, 9827591, 10179040, 8715033, 20080114819, 20080139082, 20060183090, 20140214162, 20110066239, 20020196250, 7472863, 20060016930.

Applicant focused in detail on the top ten ranked results from the deep neural network listed results, above: U.S. Pat. No. 5,868,600, 20200019157, U.S. Pat. Nos. 8,614,668, 8,760,398, 8,847,887, 8,736,548, 8,909,370, 8,571,781, 10,012,985, and 8,751,063.

Automatically generated claim charts mapping the portions of the above listed patent documents to the elements of the draft claim 1 provided in the above referenced provisional application are provided with the filing of the provisional application and are incorporated herein by reference. Those charts illustrate the novel and non-obvious nature of the present disclosure, because none of the references show devices, systems or methods analogous to the those shown herein. Specifically, do not relate to a device that can be simultaneously be used by an infant to direct an adult, and an adult to provide corrective and positive feedback to the infant, for example, among other things. These references merely relate to radio-controlled vehicles, video game consoles, and robotic figurines.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY OF THE INVENTION

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of post-AIA 35 U.S.C. § 112(f). Thus, the use of the words “function,” “means” or “step” in the Detailed Description or Description of the Drawings or claims is not intended to somehow indicate a desire to invoke the special provisions of post-AIA 35 U.S.C. § 112(f), to define the invention. To the contrary, if the provisions of post-AIA 35 U. S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . , ” if the claims also recite any structure, material or acts in support of that means or step, or that perform the recited function, then it is the clear intention of the inventor not to invoke the provisions of post-AIA 35 U.S.C. § 112(f). Moreover, even if the provisions of post-AIA 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The aspects, features, and advantages will be apparent to those artisans of ordinary skill in the art from the DETAILED DESCRIPTION and DRAWINGS, and from the CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1A depicts an exemplary device block diagram.

FIG. 1B depicts an exemplary device block diagram for a prototype implementation of the devices, systems and methods.

FIG. 1C depicts an exemplary schematic of an implementation using analog circuitry with a forward control input and display indication.

FIG. 1D depicts an exemplary schematic of an implementation using analog circuitry with a backward control input and display indication.

FIG. 1E depicts an exemplary schematic of an implementation using analog circuitry with a left control input and display indication.

FIG. 1F depicts an exemplary schematic of an implementation using analog circuitry with a right control input and display indication.

FIG. 1G depicts an exemplary schematic of an implementation using analog circuitry with a positive feedback control input and display indication.

FIG. 1H depicts an exemplary schematic of an implementation using analog circuitry with a constructive feedback control input and display indication.

FIG. 1I depicts an exemplary schematic of an implementation using an ATMEGA 328 or Arduino microcontroller with circuitry.

FIG. 1J depicts an exemplary schematic of an implementation using an ATTINY or Arduino microcontroller with circuitry.

FIG. 1K depicts an exemplary schematic of an implementation using an AM4EC microcontroller with circuitry.

FIG. 1L depicts an exemplary schematic of an implementation using an TTGO-TS ESP32 development board with circuitry.

FIG. 1M depicts another exemplary schematic of an implementation using an ATTINY or Arduino microcontroller with circuitry.

FIG. 1N depicts another exemplary schematic of an implementation using a microcontroller with switches, light emitting diodes, and a speaker.

FIG. 2A depicts device 100 and device body 200 with baby input device 104 having no deflection.

FIG. 2B depicts device 100 and device body 200 with baby input device 104 deflected forward.

FIG. 2C depicts device 100 and device body 200 with baby input device 104 deflected backward.

FIG. 2D depicts device 100 and device body 200 with baby input device 104 deflected to the left.

FIG. 2E depicts device 100 and device body 200 with baby input device 104 deflected to the right.

FIG. 2F depicts device 100 and device body 200 with adult input device 106 activated.

FIG. 2G depicts device 100 and device body 200 with adult input device 108 activated.

FIG. 3A depicts one possible exemplary user interface configuration for display 102 of device 100.

FIG. 3B depicts display 102 configured to display an active “go forward” indicator user interface element 313.

FIG. 3C depicts display 102 configured to display an active “go backward” indicator user interface element 315.

FIG. 3D depicts display 102 configured to display an active “turn left” indicator user interface element 317.

FIG. 3E depicts display 102 configured to display an active “go turn right” indicator user interface element 319.

FIG. 3F depicts display 102 configured to display a positive reinforcement/feedback or yay indicator user interface element 320.

FIG. 3G depicts display 102 configured to display an error, “oh no!” or constructive feedback indicator user interface element 322.

FIG. 4A depicts a simplified exemplary flowchart for the device operation in some forms of the device 100.

FIG. 4B depicts another simplified exemplary flowchart for the device operation in some forms of the device 100.

FIG. 4C depicts a third simplified exemplary flowchart for the device operation in some forms of the device 100.

FIG. 5A depicts a simplified exemplary flowchart for processing adult input.

FIG. 5B depicts a simplified exemplary flowchart for activating a device function in response to adult input.

FIG. 5C depicts a simplified exemplary flowchart for processing adult input.

FIG. 5D depicts a simplified exemplary flowchart for activating a device positive reinforcement function in response to adult input.

FIG. 5E depicts a simplified exemplary flowchart for activating a device error function in response to adult input is provided.

FIG. 6A depicts a simplified exemplary flowchart for processing baby input that allows for input in one of four directions (forward, backward, left, or right).

FIG. 6B depicts another simplified exemplary flowchart for processing baby input that allows for simultaneous forward/backward and left/right input for a total of eight directions.

FIG. 6C depicts a simplified exemplary flowchart for determining whether to process baby input based on the last adult input.

FIG. 6D depicts a simplified exemplary flowchart for activating a device function in response to baby input.

FIG. 7A depicts a perspective view of an exemplary form of the device.

FIG. 7B depicts a side view of an exemplary form of the device.

FIG. 7C depicts a back view of an exemplary form of the device.

FIG. 7D depicts a side perspective view of an exemplary form of the device.

FIG. 8A depicts a side view of a second exemplary form of the device.

FIG. 8B depicts a back view of the second exemplary form of the device.

FIG. 8C depicts a bottom view of the second exemplary form of the device.

FIG. 8D depicts a perspective view of the second exemplary form of the device

FIG. 9A depicts a side view of an exemplary form of a frame or body 200 for a prototype form of device 100.

FIG. 9B depicts a back view of an exemplary form of a frame or body 200 for a prototype form of device 100.

FIG. 9C depicts a bottom view of an exemplary form of a frame or body 200 for a prototype form of device 100.

FIG. 9D depicts a perspective view of an exemplary form of a frame or body 200 for a prototype form of device 100.

FIG. 9E depicts a side view of the prototype device with components (including microcontroller, display, speaker, baby joystick input, and adult input buttons) mounted to the frame.

FIG. 9F depicts a front view of the prototype device with components (including microcontroller, display, speaker, baby joystick input, and adult input buttons) mounted to the frame.

FIG. 9G depicts a back view of the prototype device with components (including microcontroller, display, speaker, baby joystick input, and adult input buttons) mounted to the frame.

FIG. 10A depicts a prototype device 100 held by a caretaker's hand (see, e.g., FIGS. 1B, 9A-9G), with display of M5StickC 120 showing a forward indication based on the baby input device 126 being manipulated forward by a baby's hand.

FIG. 10B depicts a prototype device 100 held by a caretaker's hand (see, e.g., FIGS. 1B, 9A-9G), with display of M5StickC 120 showing a backward indication based on the baby input device 126 being manipulated backward by a baby's hand.

FIG. 10C depicts a prototype device 100 held by a caretaker's hand (see, e.g., FIGS. 1B, 9A-9G), with display of M5StickC 120 showing a turn left indication based on the baby input device 126 being manipulated to the left by a baby's hand.

FIG. 10D depicts a prototype device 100 held by a caretaker's hand (see, e.g., FIGS. 1B, 9A-9G), with display of M5StickC 120 showing a turn right indication based on the baby input device 126 being manipulated to the right by a baby's hand.

FIG. 10E depicts a first view of a caretaker holding an infant, and the infant manipulating baby input 104 of device 100.

FIG. 10F depicts a second view of a caretaker holding an infant, and the infant manipulating baby input 104 of device 100.

FIG. 10G depicts a third view of a caretaker holding an infant, and the infant holding baby input 104 of device 100, but providing no directional input indicating his desire to remain stationary.

FIG. 11 depicts a map of an exemplary environment in which device 100 may be used, and an exemplary use case.

FIG. 12 depicts a map of an exemplary environment in which device 100 may be used, and an exemplary use case with a specialized game.

FIG. 13A depicts a front view of an exemplary second prototype form of device 100 showing adult input button, power switch, display, and baby joystick input.

FIG. 13B depicts a back view of an exemplary second prototype form of device 100 showing baby joystick input.

FIG. 13C depicts a left side view of an exemplary second prototype form of device 100 showing baby joystick input, speaker, microcontroller, display, adult input button, and battery.

FIG. 13D depicts a right side view of an exemplary second prototype form of device 100 showing baby joystick input, speaker, microcontroller, display, adult input button, and battery.

FIG. 13E depicts a top view of an exemplary second prototype form of device 100 showing baby joystick input, speaker, microcontroller, and display.

FIG. 14A depicts a first alternative design or form of device 100.

FIG. 14B depicts a second alternative design or form of device 100.

FIG. 14C depicts a third alternative design or form of device 100.

FIG. 14D depicts a fourth alternative design or form of device 100.

FIG. 14E depicts a fifth alternative design or form of device 100.

FIG. 14F depicts a sixth alternative design or form of device 100.

FIG. 14G depicts a seventh alternative design or form of device 100.

FIG. 15A depicts a perspective view of an exemplary production form of device 100 showing baby joystick input, display (including elements for forward, backward, left, right, and corrective feedback), the adult handle, and adult input button.

FIG. 15B depicts another perspective view of an exemplary production form of device 100 showing baby joystick input, display (including elements for forward, backward, left, right, and corrective feedback), the adult handle, and battery cover.

FIG. 15C depicts a front view of an exemplary production form of device 100 showing baby joystick input, the adult handle, and the adult input button.

FIG. 15D depicts a rear view of an exemplary production form of device 100 showing baby joystick input, the adult handle, and battery cover.

FIG. 15E depicts a top view of an exemplary production form of device 100 showing baby joystick input, and display (including elements for forward, backward, left, right, and corrective feedback).

FIG. 15F depicts a bottom view of an exemplary production form of device 100 showing the adult handle and speaker grille.

FIG. 15G depicts a left side view of an exemplary production form of device 100 showing baby joystick input, the adult handle, adult input button, and battery cover.

FIG. 15H depicts a right side view of an exemplary production form of device 100 showing baby joystick input, the adult handle, adult input button, and battery cover.

FIG. 16A depicts a father and infant son utilizing a production form of device 100 where the infant is manipulating baby input to indicate “go forward” and the father is observing the display of device 100.

FIG. 16B depicts the viewpoint of a caretaker using device 100 with an infant that is controlling the caretaker to get a closer look at a bed of flowers.

The figures are provided to aid in the understanding of the invention and their simplicity should not use to limit the scope of the invention.

Elements and acts in the figures are illustrated for simplicity and have not necessarily been rendered according to any particular sequence or embodiment, and their simplicity should not use to limit the scope of the invention.

### DETAILED DESCRIPTION

In the following description, and for the purposes of explanation, numerous specific details are set forth in order to provide a thorough understanding of the various aspects of the claimed invention. The disclosure is of course, broader than the claimed invention and is believed to contain numerous different inventions in various forms. The present disclosure describes matter, which may (in this application or a continuing application) be claimed as an invention. It will be understood, however, by those skilled in the relevant arts, that the claimed invention may be practiced without these specific details. In other instances, known structures and devices are shown or discussed more generally in order to avoid obscuring the claimed invention. In many cases, a description of the operation is sufficient to enable one to implement the various forms of the claimed invention, particularly when the operation is to be implemented in software. It should be noted that there are many different and alternative configurations, devices and technologies to which the disclosure may be applied, and which may (in this application or a continuing application) be claimed as an invention. The full scope of the disclosure which may (in this application or a continuing application) be claimed as an invention, is not limited to the examples that are described below.

Among those benefits and improvements that have been disclosed, other objects and advantages of the disclosure will become apparent from the following description taken in conjunction with the accompanying figures. Detailed forms of devices, systems and methods are disclosed herein; however, it is to be understood that the disclosed forms are merely illustrative of the numerous inventions contained in the disclosure, which may (in this application or a continuing application) be claimed as an invention, that may be embodied in various forms. In addition, each of the examples given in connection with the various forms of the devices, systems and methods disclosed which are intended to be illustrative, and not restrictive.

The subject matter regarded as the invention in the present application is particularly pointed out and distinctly claimed in the CLAIMS. The invention, however, both as to organization and method of operation, together with any provided objects, features, and advantages thereof, may best be understood by reference to the following detailed description when read with the accompanying drawings.

The figures constitute a part of this specification and include illustrative forms of the disclosed devices, systems and methods, which may (in this application or a continuing application) be claimed as an invention, and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the disclosed devices, systems and methods. Further, where considered appropriate, reference numerals may be repeated among the figures to indicate corresponding or analogous elements.

Because the illustrated forms of the disclosed devices, systems and methods may for the most part, be implemented using electronic components and circuits known to those skilled in the art, details will not be explained in any greater extent than that considered necessary, for the understanding and appreciation of the underlying concepts of the present disclosure and in order not to obfuscate or distract from the teachings of the present disclosure. However, various example implementations may be provided in order to illustrate some of the many forms in which devices, systems and methods implementing the disclosure may take.

Any reference in the specification to a method should be applied mutatis mutandis (with any necessary changes) to a device or system capable of executing the method. Any reference in the specification to a device or system should be applied mutatis mutandis to a method that may be executed by the system.

Throughout the specification and claims, the following terms take the meanings explicitly associated herein, unless the context clearly dictates otherwise. The phrases “in one embodiment,” “in one form,” “in an example embodiment,” “in an example form,” “in some embodiments,” “in some forms,” and other similar phrases as used herein do not necessarily refer to the same embodiment(s) or form(s), though it may. Furthermore, the phrases “in another embodiment,” “in another form,” “in an alternative embodiment,” “in an alternative form,” “in some other embodiments,” and “in some other forms” or similar phrases as used herein do not necessarily refer to a different embodiment or form, although it may. Thus, as described below, various forms of the devices, systems and methods disclosed herein may be readily combined, without departing from the scope or spirit of the disclosure which may (in this application or a continuing application) be claimed as an invention.

The use of the word “coupled” or “connected” implies that the elements may be directly connected or may be indirectly connected or coupled through one or more intervening elements unless it is specifically noted that there must be a direct connection.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As will be appreciated by one skilled in the art, the present disclosure describes matter, which may (in this application or a continuing application) be claimed as an invention, may be embodied as a system, method, computer program product or any combination thereof. Accordingly, this matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this matter take the form of a computer program product embodied in any tangible medium of expression having computer usable program code embodied in the medium.

The present disclosure describes matter, which may (in this application or a continuing application) be claimed as an invention, may be described in the general context of computer-executable instructions, such as program modules, being executed by a computer. Generally, program modules include routines, programs, objects, components, data structures, etc. that perform particular tasks or implement particular abstract data types. The matter may also be practiced in distributed computing environments where tasks are performed by remote processing devices that are linked through a communications network. In a distributed computing environment, program modules may be located in both local and remote computer storage media including memory storage devices.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CDROM), an optical storage device, a transmission media such as those supporting the Internet or an intranet, a magnetic storage device, a cloud storage service, or an “App” store. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present disclosure may be written in any combination of one or more programming languages, including an object-oriented programming language such as Java, Smalltalk, C++, C# or the like, conventional procedural programming languages, such as the “C” programming language, and functional programming languages such as Prolog and Lisp, machine code, assembler or any other suitabl e programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network using any type of network protocol, including for example a local area network (LAN) or a wide area network (WAN), or the connection may be made to an external computer (for example, through the Internet using an Internet Service Provider).

The present disclosure describes matter, which may (in this application or a continuing application) be claimed as an invention, is described below with reference to flowchart illustrations and/or block diagrams of methods, apparatus (systems) and computer program products according to various forms of the disclosed devices, systems and methods. It will be understood that each block of the flowchart illustrations and/or block diagrams, and combinations of blocks in the flowchart illustrations and/or block diagrams, can be implemented or supported by computer program instructions. These computer program instructions may be provided to a processor of a general-purpose computer, special purpose computer, microcontroller, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While the exemplary flowcharts presented throughout the patent disclosure may refer to software routines, they may also refer to logical flows that are embodied in the design of hardware analog circuitry or other non-programmable hardware (e.g., digital logic, etc.) without the use of custom embedded software. For example, the logical flows may be converted into digital logic formulations using a Karnaugh map and then built using digital or analog logic.

The present disclosure describes matter, which may (in this application or a continuing application) be claimed as an invention, that is operational with numerous general purpose or special purpose computing system environments or configurations. Examples of well-known computing systems, environments, and/or configurations that may be suitable for use with the disclosed devices, systems and methods include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

### Hardware—General Functional Block Diagram

In various forms of the devices, systems and methods, different hardware components can be utilized, omitted, or substituted. A functional block diagram follows, describing at a high-level various hardware components or functions that may be implemented in varying combinations and arrangements different forms of the invention. The connections between the blocks in the diagram are also illustrative of merely one form of the disclosure and the blocks may be connected in any other manner.

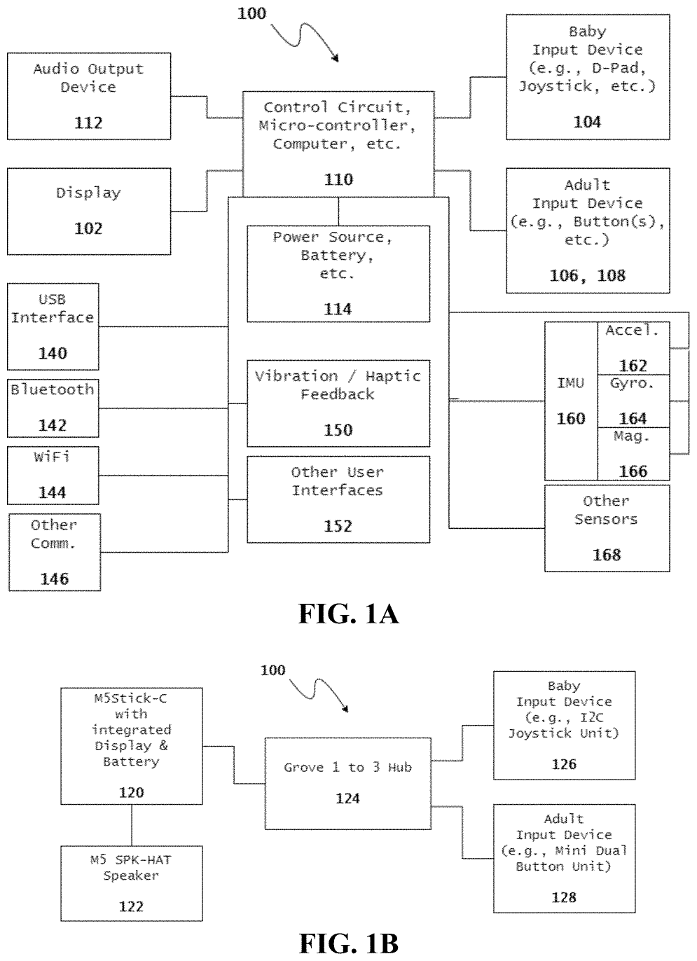

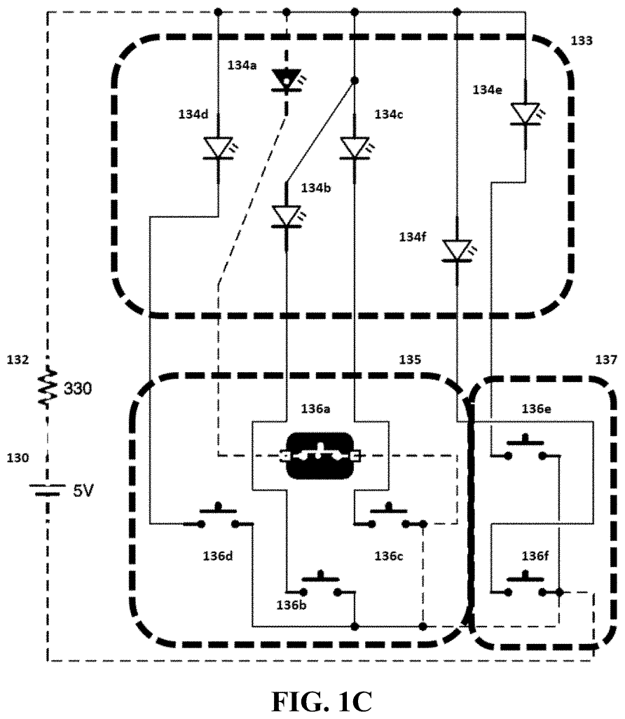

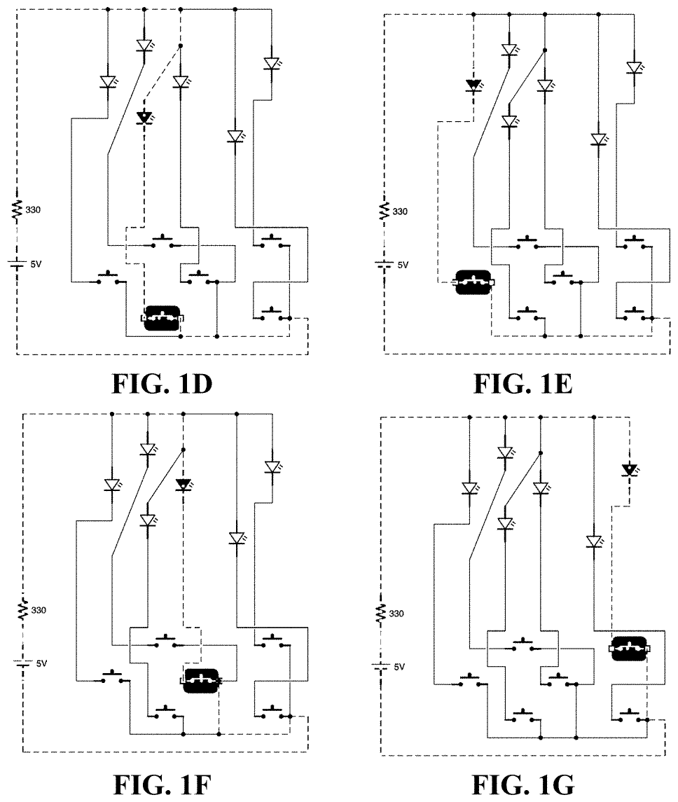

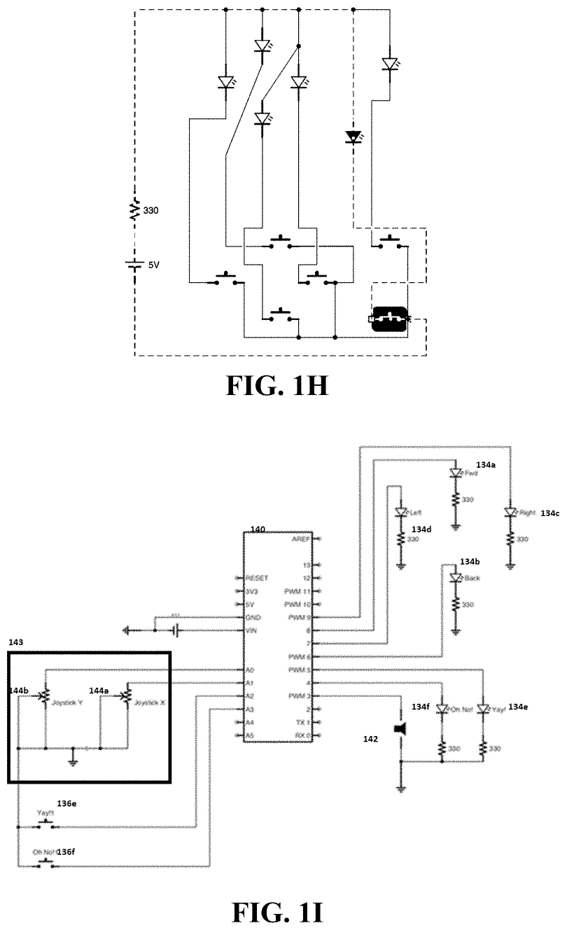

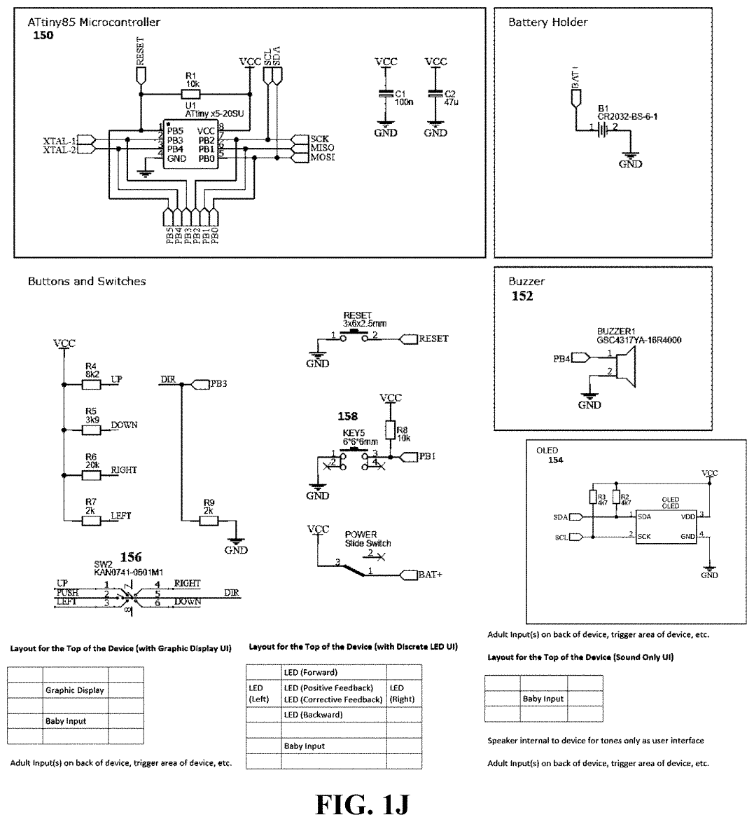

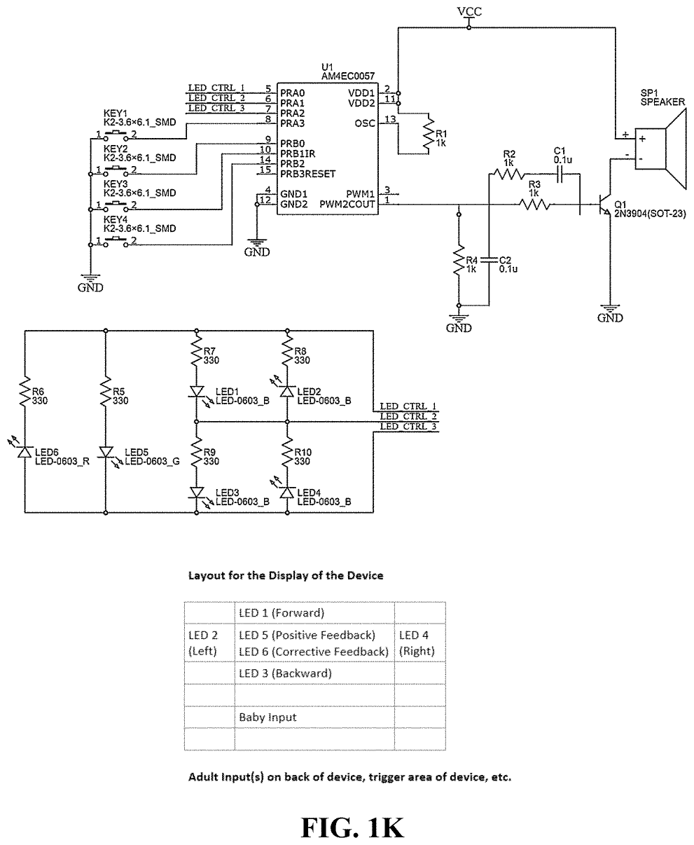

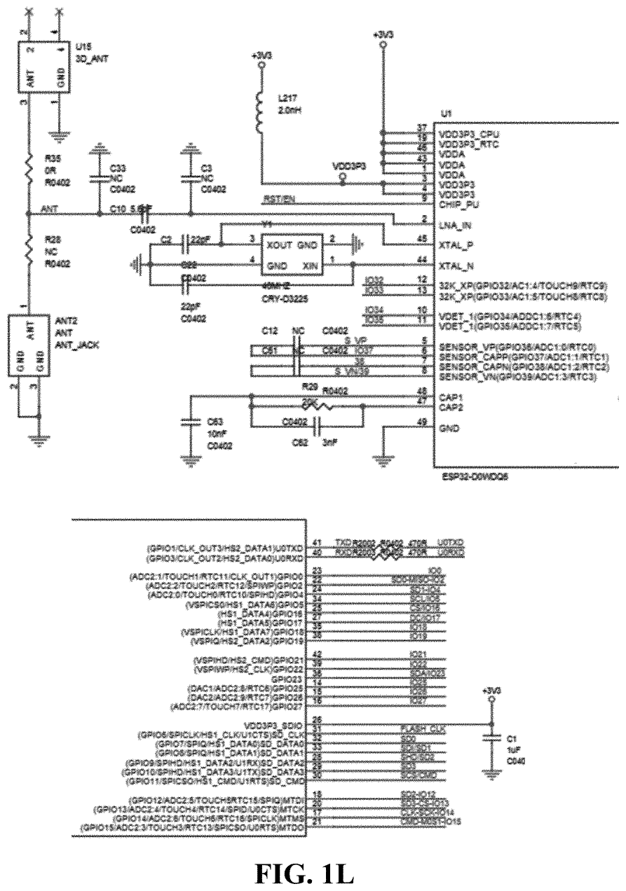

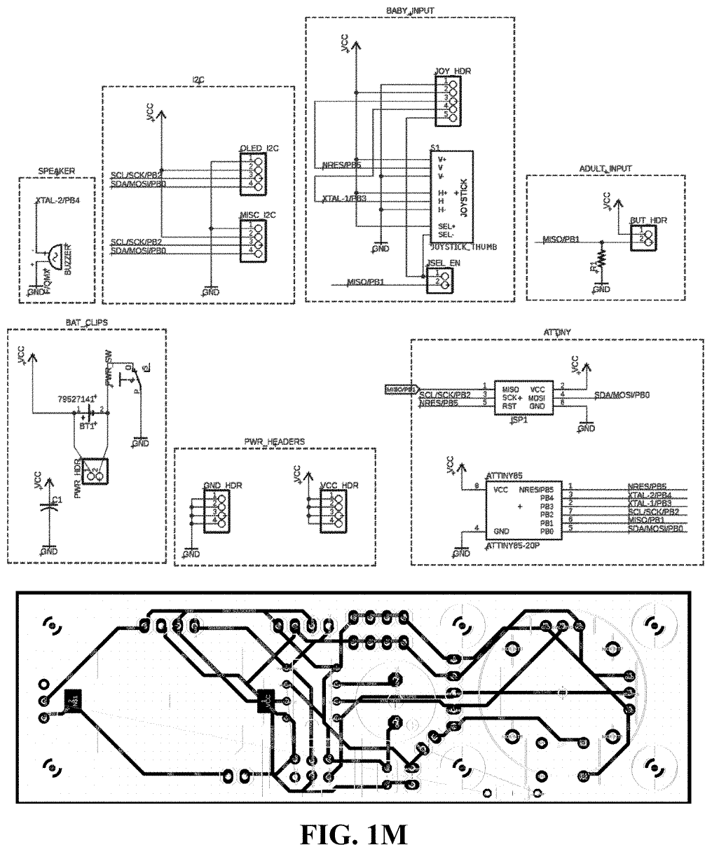

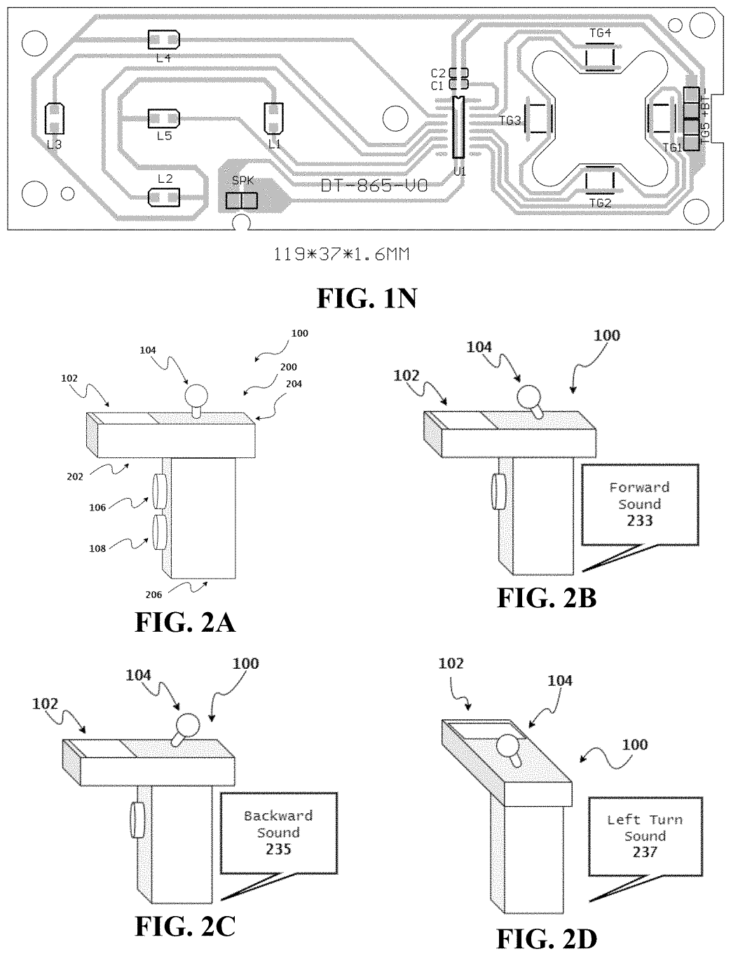

Referring to FIG. 1A, the numeral 100 generally designates a block diagram for a device contemplated herein.

As will be more fully described below, apparatus 100 is configured to enhance the development an individual by helping a baby develop hand-eye coordination, spatial awareness, and interact with a caregiver or the individual whose developmental skills are being enhanced.

In the illustrated embodiment, apparatus 100 is configured in the form of a toy, and more particularly many forms of the invention may have the appearance of a joystick controller adapted for the simultaneous use by the baby and an adult caretaker. In this manner, the directional input may be provided by the baby a directional input device such as a joystick, and the caregiver may have the ability to input or trigger functions on the toy through one or more input devices such as one or more buttons. Though it should be understood that other types of input, movement, or sensed physical manipulations of the toy can be used as input to trigger functions of the toy.

Referring to FIG. 1A, apparatus 100 may include any combination of the following: a display 102, a baby input device (e.g., an appropriately sized joystick, etc.) 104, an adult input device(s) (e.g., buttons on a portion of the device held by the adult, etc.) 106 and/or 108, a control circuit 110, an audio output device 112 and/or a power source 114. In addition, some forms of the device may further include any one or combination of the following additional features: a USB Interface 140, Bluetooth Interface 142, Wi-Fi Interface 144, Other Communications Interface 146, Vibration or Haptic Feedback Device(s) 150, Other User Interface(s) or Feedback Devices 152, an Inertial Measurement Unit 160, an Accelerometer 162, Gyroscope 164, Magnetometer 166 and/or Other Sensor(s) 168.

In forms of the device incorporating a display 102, a display device may be any one or combination of the following: light emitting diodes (LEDs), LEDs with printed overlay (e.g., printed graphic where light shines through, LED under a printed directional arrow, symbol, or word), LEDs with a plastic overlay, LEDs with a shaped diffuser to shape the light, liquid crystal displays, led matrix displays, organic light emitting diode matrix displays, or any other type of display device.

The baby input device 104 is generally an input device suited for use by a baby's hands to provide directional input (e.g., forward, backward, left, right, x, y, or combinations thereof). The baby input may also provide for a button press input to trigger a function on the device. In some forms of the device, the button press input is activated by pressing down on the directional input. The button press input may also be triggered by a shaking motion or other action. For purposes of illustration and without limitation the directional input may be a: baby-sized joystick input, an adult-sized thumb input, a d-pad input, a d-pad input with an overlay sized to fit a baby's hands and enable a baby to provide input to the d-pad, a 5-way tactile switch with an attachment sized to fit a baby's hands and enable a baby to provide input to the 5-way tactical switch, or any other input device.

The adult input device(s) 106 and/or 108 may any kind of input device or combination of input devices, including: buttons, triggers, multi-directional switches, touch input devices, or any other type of input device. The adult input devices be configured trigger a positive reinforcement function (e.g., “good job!,” a happy noise, etc.), or a constructive feedback function (e.g., “let's try going a different direction”, a noise indicating that there was an issue, etc.) or other feature.

The control circuit 110 may be any kind of circuit or combination of circuits, including: analog circuitry, digital circuitry, one or more microcontrollers, one or more field programmable gate arrays (FPGA), one or more application specific integrated circuits (ASIC), or any other type of electronic device or circuitry.

In forms of the device incorporating an audio output device 112 or haptic feedback device, the audio output or haptic feedback device may be any one or combination of the following: speaker, buzzer, vibration motor, or any other type of audible or sensory feedback device.

The power source 114 may be any type of power source including a wired power source (e.g., an AC adapter, etc.), a wireless power source (e.g., a wireless charger such as one that operates with the Qi standard, etc.), a standard battery or combination of batteries (e.g., Coin Cell, AA, AAA, 9V, etc.), or a rechargeable battery (e.g., 18650, LiPo, NiMH, etc.).

The device 100 may implement one or more communication interfaces such as: a USB Interface 140, Bluetooth Interface 142, Wi-Fi Interface 144, or any other communications interface 146.

The device 100 may also implement vibration or haptic feedback device(s) 150, or other user interface(s) or feedback devices 152.

The device 100 may also implement different sensors such as an Inertial Measurement Unit (IMU) 160 (which may contain an Accelerometer 162, Gyroscope 164, Magnetometer 166), or the device may incorporate one or more individual Accelerometer 162, Gyroscope 164, Magnetometer 166 sensors apart from an IMU. Device 100 may also include any other type of sensor(s) 168.

Device Body, Housing or Enclosure.

Generally, the device 100 has a body or casing that provides a place for device components and provides at least some of the structure of the device.

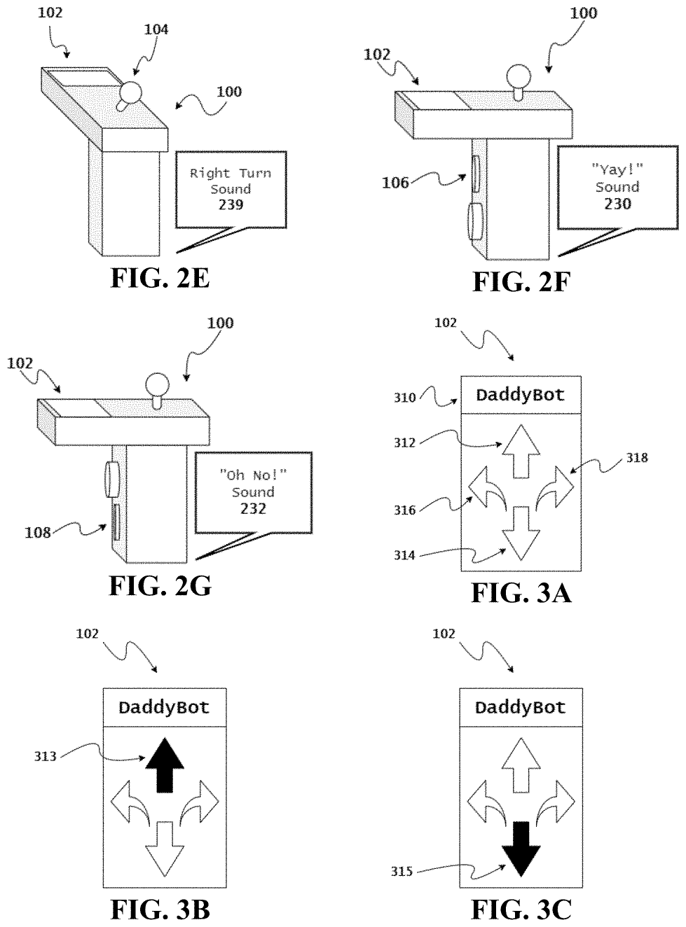

With reference to FIG. 2A, device 100 is housed in or on a body 200. The body 200 may be made using any manufacturing technique, material, or combination thereof such as 3D Printing, Injection Molding, Milling, Vacuum Forming, Laser Cutting, etc. with plastics, acrylics, wood, metal, etc.

In forms of the device including a display device 102, body 200 may include a display area 202 for mounting or housing display 102.

The body 200 of device 100 may also include a baby control input area 204 for mounting or housing a baby input device or joystick 104.

The body 200 of device 100 may also include an adult grip area 206. In forms of the invention including adult user input button(s) 106 and/or 108, the adult user input buttons may be housed in or mounted on the adult grip area 206. For purposes of illustration and without limitation this adult user input button(s) 106 and/or 108 may both be placed on the same area of the device, or may be placed on different areas of the device. There may be more or less than two adult user input button(s). Adult user input button(s) need not be buttons per se but could be other forms of user input devices. Such buttons or other user input devices may be placed on:
the “trigger” or front area of a “pistol” grip 206;
the back of a grip 206;
above the grip on the back of the device 100 body 200;
behind the baby input area 204
on top of the device 100 body 200;
under the display area 204;
Any other area of the device 100 body 200;
Parent buttons on the back of the device to simplify manufacture.

In some forms of the invention, the baby control input area 204 is substantially horizontal while the display area 202 is elevated at an angle (e.g., 45 degrees, etc.) as to appropriately angle the display to be best viewed by the adult holding the device. However, the display area 202 may be substantially horizontal.

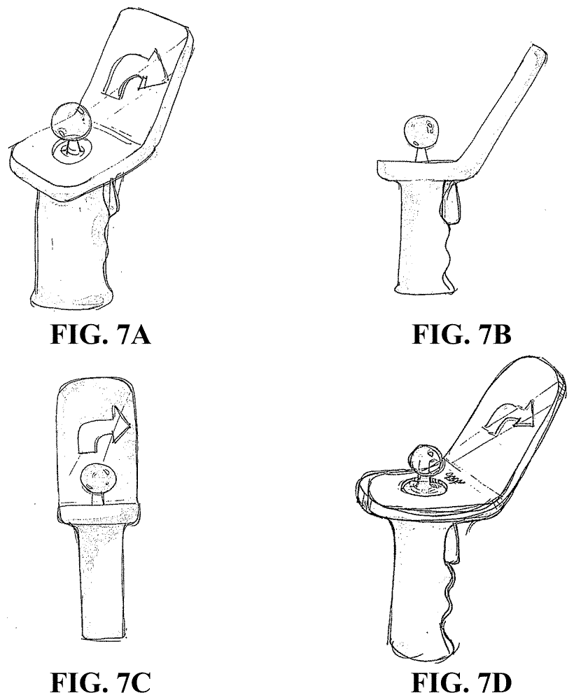

With reference to FIGS. 7A-7D, illustrations of another form of device 100 body 200 are shown. FIG. 7A shows a perspective view of an exemplary form of the device. FIG. 7B shows a side view of an exemplary form of the device. FIG. 7C shows a back view of an exemplary form of the device. FIG. 7D shows a side perspective view of an exemplary form of the device.

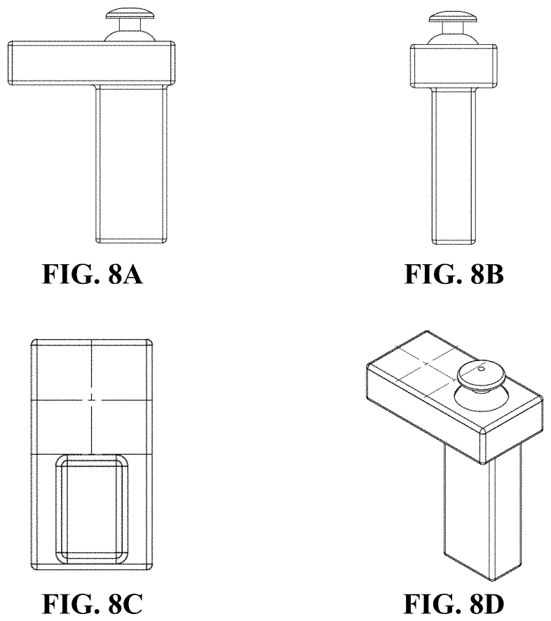

With reference to FIGS. 8A-8D, illustrations of another form of device 100 body 200 are shown. FIG. 8A shows a side view of an exemplary form of the device. FIG. 8B shows a back view of an exemplary form of the device. FIG. 8C shows a bottom view of an exemplary form of the device. FIG. 8D shows a perspective view of an exemplary form of the device.

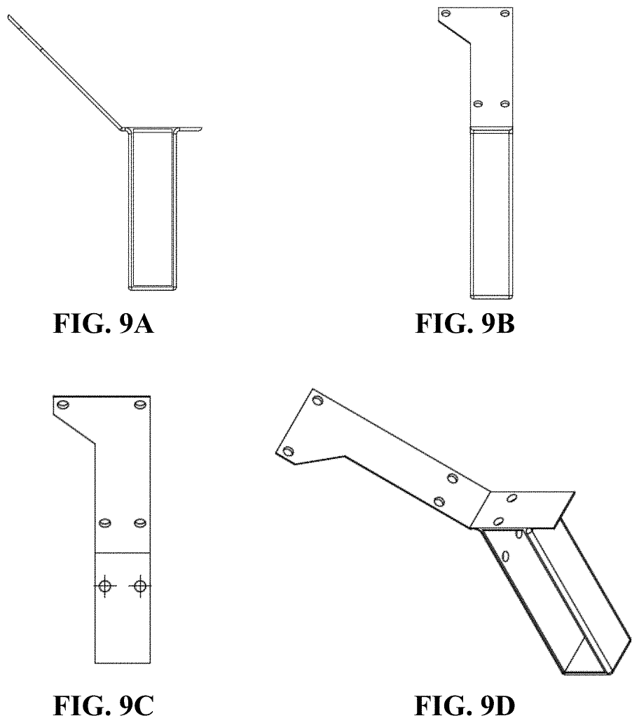

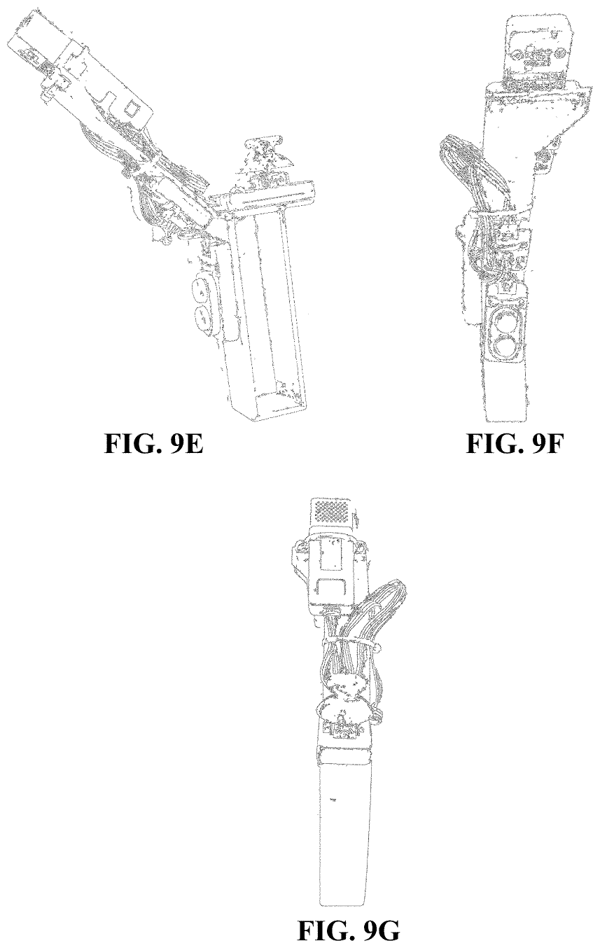

With reference to FIGS. 9A-9D, illustrations of a prototype form of device 100 (see, e.g., FIG. 1B, etc.) body 200 that was constructed for testing are shown. FIG. 9A shows a side view of an exemplary form of the device. FIG. 9B shows a back view of an exemplary form of the device. FIG. 9C shows a bottom view of an exemplary form of the device. FIG. 9D shows a perspective view of an exemplary form of the device.

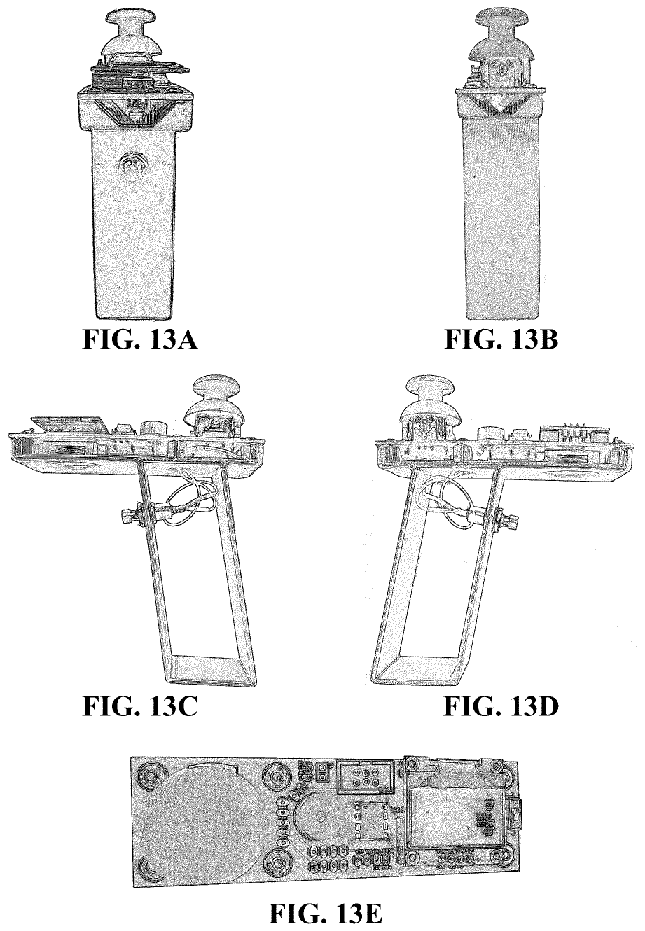

With reference to FIGS. 13A-13E, illustrations of a second prototype form of device 100 (see, e.g., FIG. 1M, etc.) body that was constructed for testing are shown. FIG. 13A depicts a front view of an exemplary second prototype form of device 100 showing adult input button, power switch, display, and baby joystick input. FIG. 13B depicts a back view of an exemplary second prototype form of device 100 showing baby joystick input. FIG. 13C depicts a left side view of an exemplary second prototype form of device 100 showing baby joystick input, speaker, microcontroller, display, adult input button, and battery. FIG. 13D depicts a right-side view of an exemplary second prototype form of device 100 showing baby joystick input, speaker, microcontroller, display, adult input button, and battery. FIG. 13E depicts a top view of an exemplary second prototype form of device 100 showing baby joystick input, speaker, microcontroller, and display.

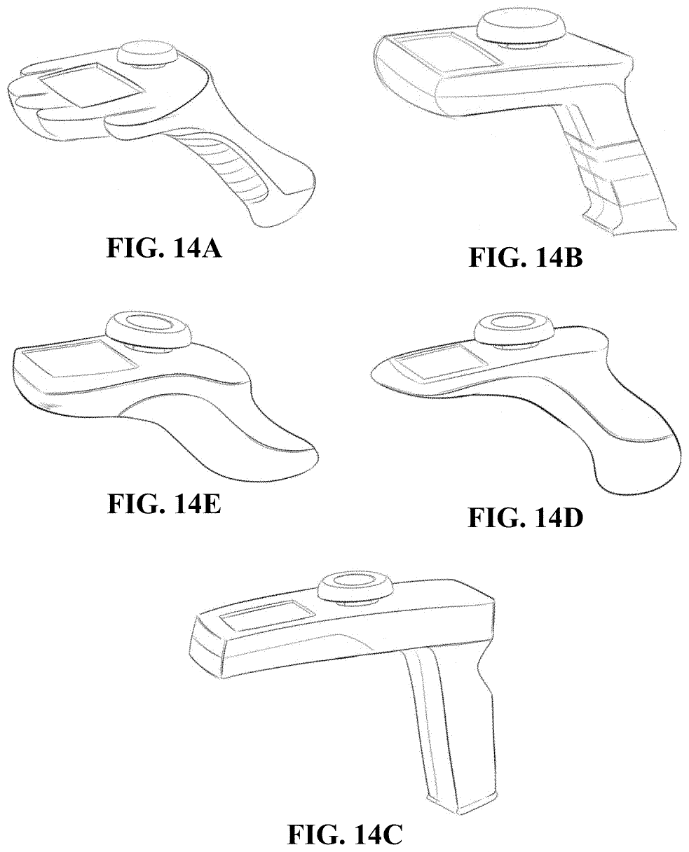

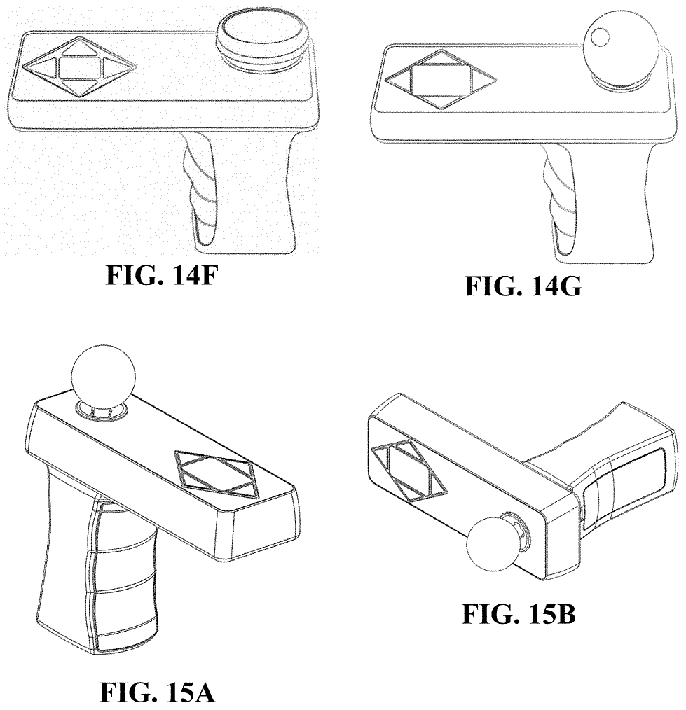

With reference to FIGS. 14A-14G, illustrations of different possible variations of the design for a production version of device 100 are shown. FIG. 14A depicts a first alternative design or form of device 100. FIG. 14B depicts a second alternative design or form of device 100. FIG. 14C depicts a third alternative design or form of device 100. FIG. 14D depicts a fourth alternative design or form of device 100. FIG. 14E depicts a fifth alternative design or form of device 100. FIG. 14F depicts a sixth alternative design or form of device 100. FIG. 14G depicts a seventh alternative design or form of device 100.

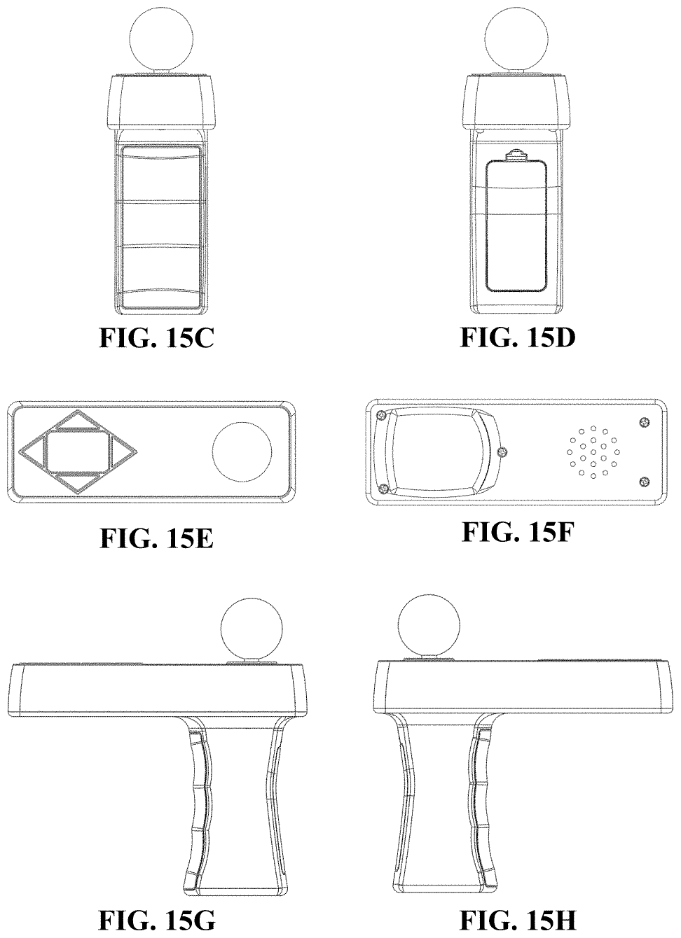

With reference to FIGS. 15A-15E, illustrations of a design for a production version of device 100 is shown. FIG. 15A depicts a perspective view of an exemplary production form of device 100 showing baby joystick input, display (including elements for forward, backward, left, right, and corrective feedback), the adult handle, and adult input button. FIG. 15B depicts another perspective view of an exemplary production form of device 100 showing baby joystick input, display (including elements for forward, backward, left, right, and corrective feedback), the adult handle, and battery cover. FIG. 15C depicts a front view of an exemplary production form of device 100 showing baby joystick input, the adult handle, and the adult input button. FIG. 15D depicts a rear view of an exemplary production form of device 100 showing baby joystick input, the adult handle, and battery cover. FIG. 15E depicts a top view of an exemplary production form of device 100 showing baby joystick input, and display (including elements for forward, backward, left, right, and corrective feedback). FIG. 15F depicts a bottom view of an exemplary production form of device 100 showing the adult handle and speaker grille. FIG. 15G depicts a left side view of an exemplary production form of device 100 showing baby joystick input, the adult handle, adult input button, and battery cover. FIG. 15H depicts a right-side view of an exemplary production form of device 100 showing baby joystick input, the adult handle, adult input button, and battery cover.

### User Interface

In addition to the hardware inputs, the device 100 has a user interface to indicate the results of the inputs. The user interface may consist of audio, visual, haptic, or any other type or combination of features.

Generally, the user interface provides indications for directional commands based on the input received from the infant, and in some forms of the invention positive and corrective feedback based on input received from the adult.

In forms of the device, systems, and methods including audio user interface elements, the audio may be produced using, for example, a speaker or a buzzer or any other transducer. The audio may be beeps, tones, synthesized voice, recordings, or any other type of audio. Different beeps, tones, synthesized voices, synthesized words, synthesized phrases, recordings or other audio may be played in response to different inputs into the device. In forms with an audio user interface, there may be a silent mode for times when audio interface is not desired. The silent mode may be implemented with hardware (e.g., a switch that breaks the connection with the audio hardware, a switch that instructs a microcontroller to stop outputting sound to audio hardware, etc.), software (e.g., microcontroller code that observes a device state and then enables or disables audio), or both.

In forms of the device, systems, and methods including visual user interface elements, the visual user interface may be produced using any type of display element including for example LED lights, graphic displays (e.g., OLED matrix, etc.) or any other type of display. Different display elements or graphics may be shown in response to different inputs into the device.

For purposes of illustration and without limitation, some forms of the invention may have a visual user interface component including light-emitting diodes. The light emitting diodes may all be the same color, or they may have different colors. Directional indicator LEDs may all be the same color, or may have different colors (e.g., red, green, orange, white, blue). In one possible configuration a red color led may be used for the turn left LED, a green color used for the turn right LED, white or blue may be used for the go forward LED and orange may be used for the go back LED. Any colors may be used. Alternatively, RGB or other LEDs with configurable colors may be used for all or some of the LEDs.

For purposes of illustration and without limitation, some forms of the invention may have a visual user interface including an arrangement or matrix such as a ring of LEDs, a matrix of LEDs, an OLED or other graphic display, etc. In these forms of the invention, a graphic symbol may be utilized on the display, or an animation may be used to visually stimulate the child while communicating the desired input from the child to the adult. For example, gradient motion from back to front could signify “go forward.” Similarly, gradient motion from front to back could indicate “go backward.” Gradient motion from left to right could signify “turn right,” and gradient motion from right to left could signify “go left.” In the case of a ring of LEDs, the lights could illuminate in a gradient or other manner based on the baby's input (e.g., forward input causes the forward/top portion of the ring to illuminate in a gradient or other manner, etc.)

For purposes of illustration and without limitation, some forms of the invention may have an audio user interface that is associated with a visual user interface. Audio may further associate directions with the different colors (red, left) by vocalizing the word associated with the direction “left” either with synthesized voice or recording. In addition, this feature may be multilingual to expose young children to even a small subset of a different languages at a very young age.

In forms of the device, systems, and methods including haptic user interface elements, the haptic feedback may be produced using a vibration motor, tap motor, or any other device. The haptic feedback may be vibrations, buzzes, taps, patterns, force feedback, etc. Different haptic feedback may be actuated in response to different inputs into the device.

Following paragraphs are illustrations of user interfaces for one of many forms of the device, and may be adapted as necessary or appropriate for other forms of the device with additional or fewer inputs, functions, or capabilities. These are merely for purposes of illustration without limitation and therefore should not be used to limit the scope of any claimed invention.

### User Interface—General

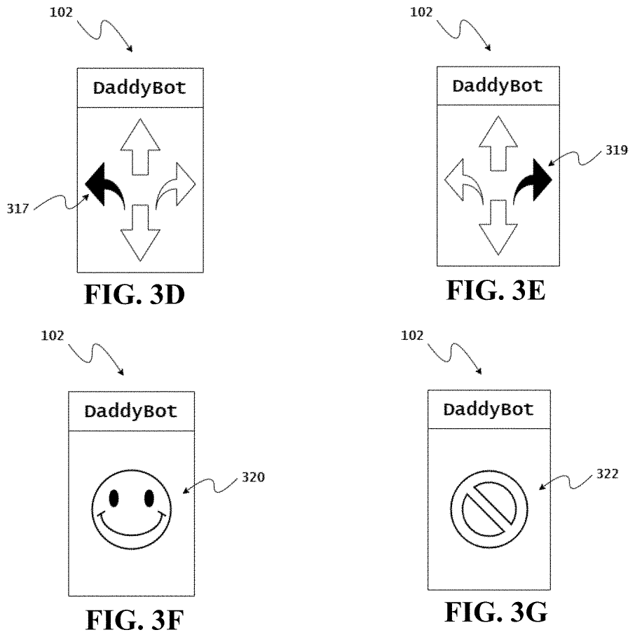

With respect to FIGS. 2A-2G and 3A-3G, device 100 body 200 and display 102 provides a user interface.

In some forms of the device, the display 102 is a LCD, LED, OLED, or other graphic matrix display. In other forms of the device, the display may also be a simple display made from individual display elements each representing a different output (e.g., four LEDs; one for each direction: forward backward left and right, etc.) Any type of display device, elements, or method may be used. Accordingly, the user interface may take any number of different forms of appearance. The depicted examples are provided for purposes of illustration and without limitation.

With reference to FIG. 3A, a logo area 310 is illustrated. In various forms of the device, the logo area 310 is a printed sticker that is adhered on to the device 100. In other forms of the device, the logo area is molded into device body 200. For example, the logo may be placed on any surface of the body including the top or side. In other forms of the device, the logo area 310 is displayed on a graphic screen installed in the device 100.

In forms of the device where the logo area 310 is displayed on a graphic screen, the logo may be selectable via a user configuration menu. The menu may be accessible through use of user interface elements on the device 100 such as joystick 104 and buttons 106, 108. Additionally, or alternatively, the configuration may also be updated via a remote device (e.g., such as a computer or mobile phone) via Bluetooth, WiFi, USB, a WebPage, an “App”, or any other method.

In forms of the invention where the logo is customizable and it is applied to the device as a sticker or other physical item, the logo may be a customizable sticker. For purposes of illustration and without limitation, the sticker may be a “coloring book” line drawing of a segmented display (e.g. 7-segment, 9-segment, 14-segment, 16-segment, dot-matrix, comic book style, fonts, individual letters, label maker, custom downloaded graphics produced on a computer, etc.) or other style drawing that can be colored in and applied to the device to customize it for a particular child.

In forms of the invention where the logo is customizable and is displayed on a display of the device, the logo may be updated in the user configuration area to display one of a number of preset logos (e.g., DaddyBot, DadaBot, MommyBot, MamaBot, PapaBot, GrandmaBot, BabyBot, TotBot, Tot-Bot, WeeBot, etc.). Alternatively, in various forms of the device, the logo may be set to a value such as the child's name, (e.g., Theo, Everette, Brooks, etc.), or a variation of the name (e.g., TheoBot, EveretteBot, BrooksBot, etc.)

With reference to FIG. 2A, the exemplary device 100 has no user input provided to the baby input 104 or adult input(s) 106 or 108. Specifically, device 100 is depicted with baby input device 104 in a position indicating no input (or input that does not exceed a minimum threshold). Each of the adult input buttons 106 and 108 similarly have no input (e.g., they are not depressed, etc.).

With refence to FIG. 3B, display 102 may be configured to display a blank screen, only the logo 310, or any combination of the inactive forward 312, back 314, left 316 or right 318 directional indicators.

### User Interface—Forward

The user interface on display 102 of device 100 is updated when the baby input device receives a forward command.

With reference to FIG. 2B, device 100 is depicted with baby input device 104 deflected forward. In practice, the baby input device 104 would be deflected by the hand of a baby or the thumb of a caretaker demonstrating the device to a baby. In some forms of the device, a “go forward” sound 233 (e.g., beeps, music notes, synthesized voice, recordings, etc.) may also be audibly produced by the device 100.

With refence to FIG. 3B, display 102 is configured to display an active “go forward” indicator user interface element 313.

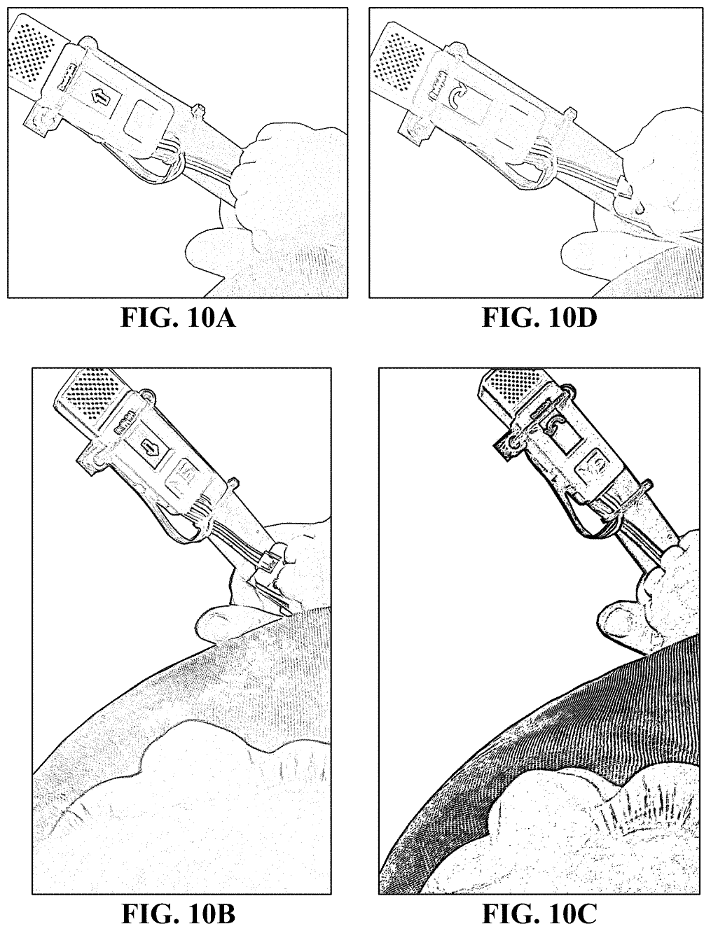

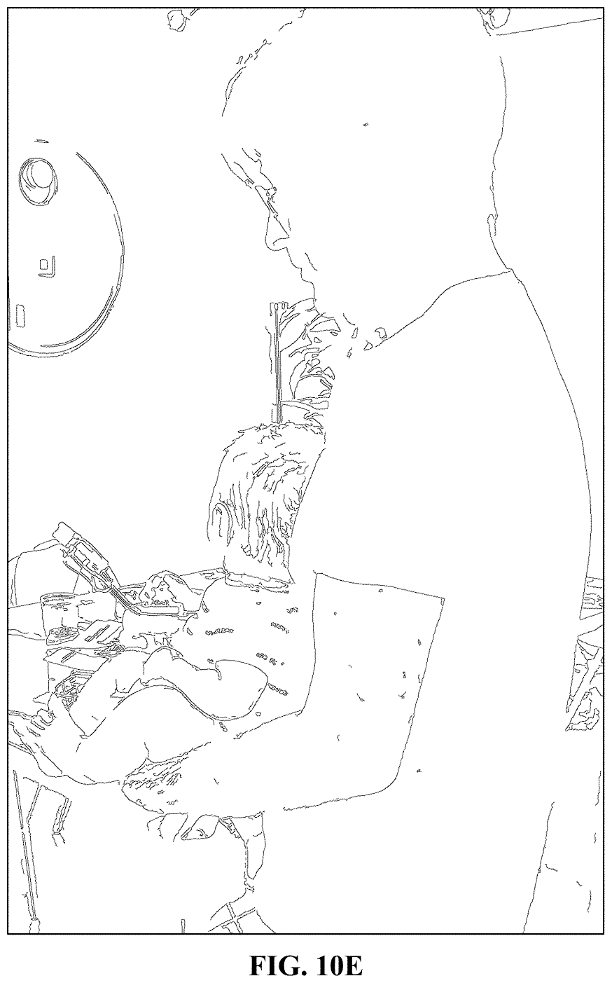

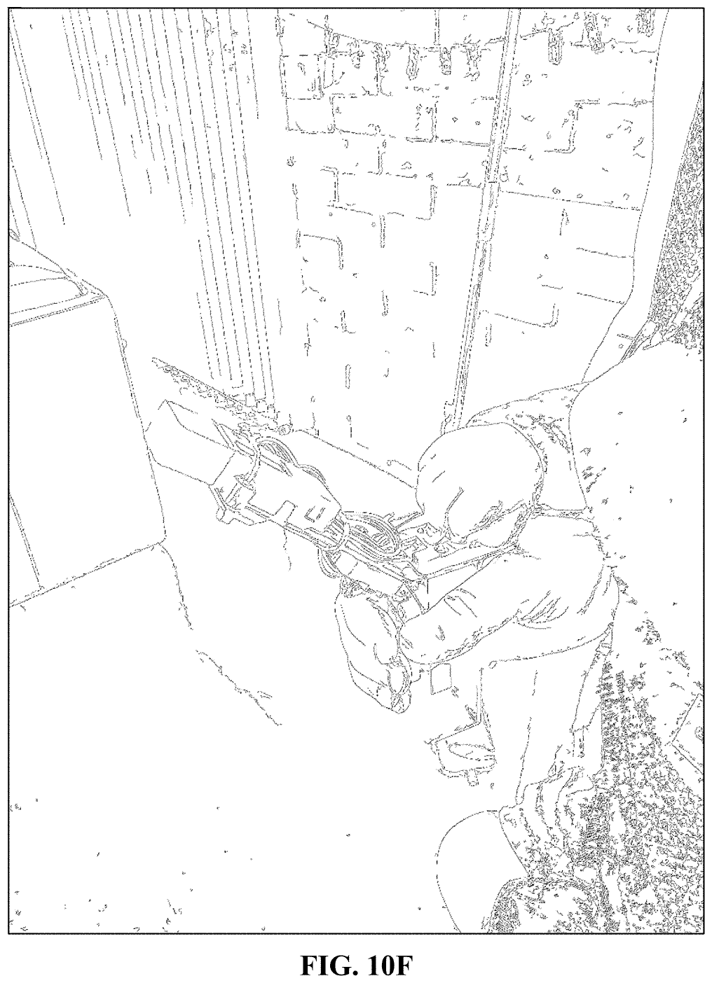

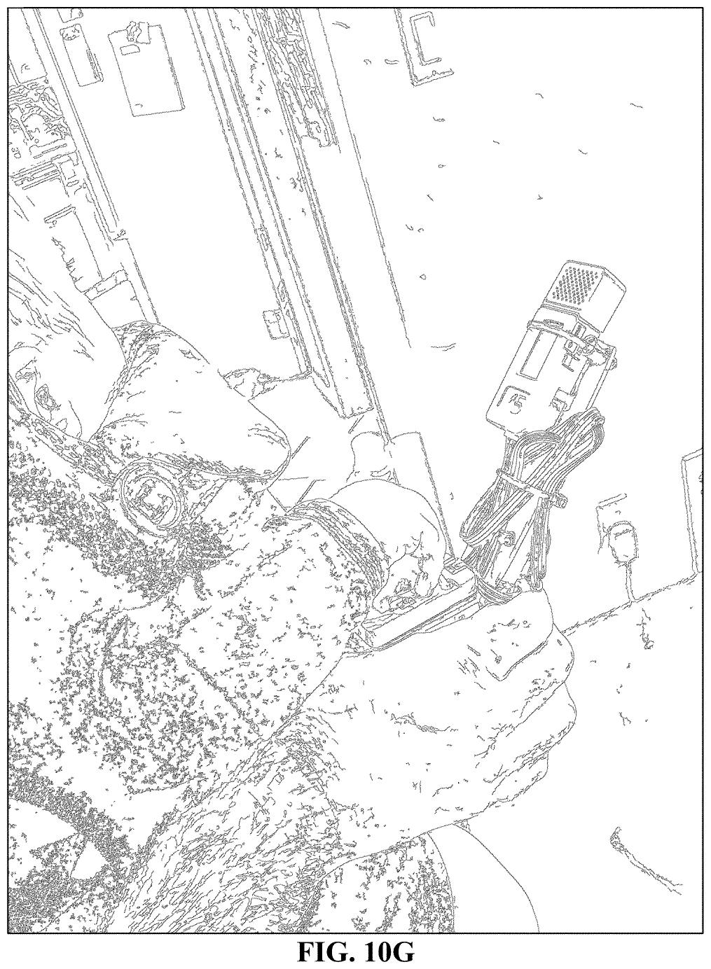

With reference to FIG. 10A, a prototype device 100 (see, e.g., FIG. 1B, FIGS. 9A-9G), is depicted with display of M5StickC 120 showing a forward indication based on the baby input device 126 being manipulated forward by a baby's hand.

### User Interface—Backward

The user interface on display 102 of device 100 is updated when the baby input device receives a backward command.

With reference to FIG. 2C, device 100 is depicted with baby input device 104 deflected backward. In practice, the baby input device 104 would be deflected by the hand of a baby or the thumb of a caretaker demonstrating the device to a baby. In some forms of the device, a “back up” sound 235 (e.g., beeps, music notes, synthesized voice, recordings, etc.) may also be audibly produced by the device 100.

With refence to FIG. 3C, display 102 is configured to display an active “go backward” indicator user interface element 315.

With reference to FIG. 10B, a prototype device 100 (see, e.g., FIG. 1B, FIGS. 9A-9G), is depicted with display of M5StickC 120 showing a backward indication based on the baby input device 126 being manipulated backward by a baby's hand.

### User Interface—Left

The user interface on display 102 of device 100 is updated when the baby input device receives a turn left command.

With reference to FIG. 2D, device 100 is depicted with baby input device 104 deflected to the left. In practice, the baby input device 104 would be deflected by the hand of a baby or the thumb of a caretaker demonstrating the device to a baby. In some forms of the device, a “turn left” sound 237 (e.g., beeps, music notes, synthesized voice, recordings, etc.) may also be audibly produced by the device 100.

With refence to FIG. 3D, display 102 is configured to display an active “turn left” indicator user interface element 317.

With reference to FIG. 10C, a prototype device 100 (see, e.g., FIG. 1B, FIGS. 9A-9G), is depicted with display of M5StickC 120 showing a turn left indication based on the baby input device 126 being manipulated to the left by a baby's hand.

### User Interface—Right

The user interface on display 102 of device 100 is updated when the baby input device receives a turn right command.

With reference to FIG. 2E, device 100 is depicted with baby input device 104 deflected to the right. In practice, the baby input device 104 would be deflected by the hand of a baby or the thumb of a caretaker demonstrating the device to a baby. In some forms of the device, a “turn right” sound 239 (e.g., beeps, music notes, synthesized voice, recordings, etc.) may also be audibly produced by the device 100.

With refence to FIG. 3E, display 102 is configured to display an active “go turn right” indicator user interface element 319.

With reference to FIG. 10D, a prototype device 100 (see, e.g., FIG. 1B, FIGS. 9A-9G), is depicted with display of M5StickC 120 showing a turn right indication based on the baby input device 126 being manipulated to the right by a baby's hand.

### User Interface—Baby Input Flowcharts

The exemplary flowcharts presented throughout the patent disclosure may refer to software routines, or logical flows that are embodied in analog or other non-programmable hardware (e.g., digital logic, etc.).

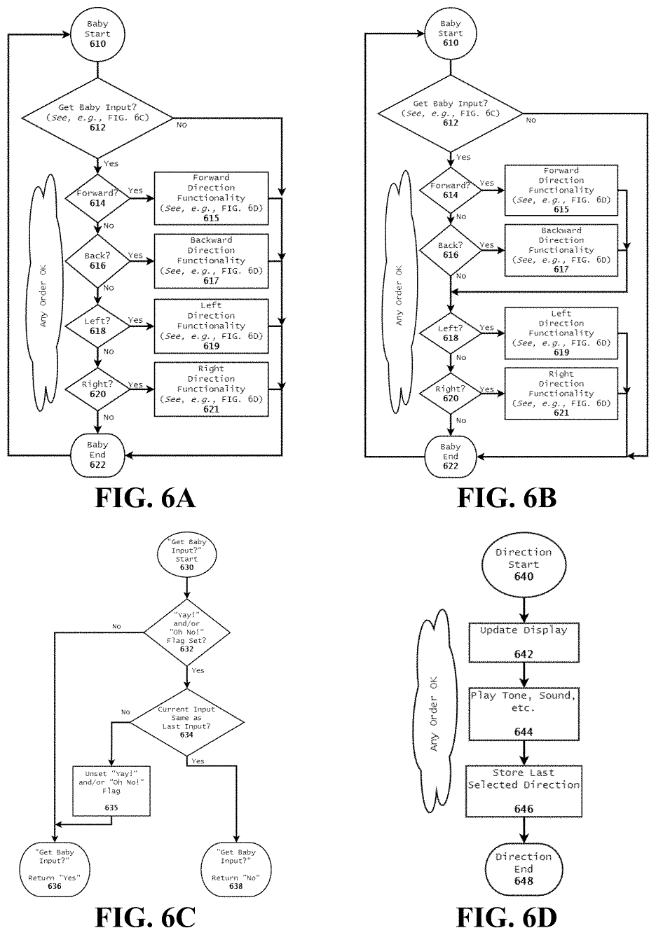

With reference to FIG. 6A, a simplified exemplary flowchart for processing baby input is provided that allows for input in one of four directions (forward, backward, left, or right).
At act 610, the process starts.
At act 612, a determination is made whether to get the input provided by the baby input device. See, e.g., FIG. 6C for a simplified exemplary flowchart for making this determination. If it is determined that the baby input should not be considered, the process jumps to the end at act 622. If it is determined that the baby input should be considered, the process continues.
The following acts may occur in any order.
At act 614, the baby input is examined to determine if a forward input is provided. If no, then the process continues to act 616. If yes, then the process continues to act 615. At act 615, forward direction functionality is executed on device 100. See, e.g., FIG. 6D for a simplified exemplary flowchart of implementing device functionality in response to baby input. After act 615, the process concludes at act 622.
At act 616, the baby input is examined to determine if a backward input is provided. If no, then the process continues to act 618. If yes, then the process continues to act 617. At act 617, backward direction functionality is executed on device 100. See, e.g., FIG. 6D for a simplified exemplary flowchart of implementing device functionality in response to baby input. After act 617, the process concludes at act 622.
At act 618, the baby input is examined to determine if a turn left input is provided. If no, then the process continues to act 620. If yes, then the process continues to act 619. At act 619, left direction functionality is executed on device 100. See, e.g., FIG. 6D for a simplified exemplary flowchart of implementing device functionality in response to baby input. After act 619, the process concludes at act 622.
At act 620, the baby input is examined to determine if a turn right input is provided. If no, then the process continues to act 622. If yes, then the process continues to act 621. At act 621, right direction functionality is executed on device 100. See, e.g., FIG. 6D for a simplified exemplary flowchart of implementing device functionality in response to baby input. After act 621, the process concludes at act 622.
At act 622, the process ends.

With reference to FIG. 6B, another simplified exemplary flowchart for processing baby input is provided that allows for simultaneous forward/backward and left/right input for a total of eight directions.
At act 610, the process starts.
At act 612, a determination is made whether to get the input provided by the baby input device. See, e.g., FIG. 6C for a simplified exemplary flowchart for making this determination. If it is determined that the baby input should not be considered, the process jumps to the end at act 622. If it is determined that the baby input should be considered, the process continues.
The following acts may occur in any order.
At act 614, the baby input is examined to determine if a forward input is provided. If no, then the process continues to act 616. If yes, then the process continues to act 615. At act 615, forward direction functionality is exeuted on device 100. See, e.g., FIG. 6D for a simplified exemplary flowchart of implementing device functionality in response to baby input. After act 615, the process continues at act 618.
At act 616, the baby input is examined to determine if a backward input is provided. If no, then the process continues to act 618. If yes, then the process continues to act 617. At act 617, backward direction functionality is executed on device 100. See, e.g., FIG. 6D for a simplified exemplary flowchart of implementing device functionality in response to baby input. After act 615, the process continues at act 618.
At act 618, the baby input is examined to determine if a turn left input is provided. If no, then the process continues to act 620. If yes, then the process continues to act 619. At act 619, left direction functionality is executed on device 100. See, e.g., FIG. 6D for a simplified exemplary flowchart of implementing device functionality in response to baby input. After act 619, the process concludes at act 622.
At act 620, the baby input is examined to determine if a turn right input is provided. If no, then the process continues to act 622. If yes, then the process continues to act 621. At act 621, right direction functionality is executed on device 100. See, e.g., FIG. 6D for a simplified exemplary flowchart of implementing device functionality in response to baby input. After act 621, the process concludes at act 622.
At act 622, the process ends.

With reference to FIG. 6C, a simplified exemplary flowchart for determining whether to process baby input, based on the last adult input, is provided.
At act 630, the process starts.
At act 632, a determination is made whether a flag was set (e.g., a positive feedback flag, a constructive feedback flag, etc.) was set. If no flag was set, the process proceeds to act 636. If a flag was set, the process proceeds to act 634.
At act 634, the current baby input is compared to the last baby input. If the two are not the same (e.g., last baby input was forward and the current baby input is turn left, etc.) then the process proceeds to act 635. If the two are the same (e.g., last baby input was forward, and the current baby input is forward, etc.), then the process proceeds to act 638.
At act 635, the relevant flag is unset and the process proceeds to act 636.
At act 636, a “yes” determination is reported back to any procedure that considers this result. See, e.g., FIGS. 6A and 6B.
At act 638, a “no” determination is reported back to any procedure that considers this result. See, e.g., FIGS. 6A and 6B.

With reference to FIG. 6D, a simplified exemplary flowchart for activating a device function in response to baby input is provided. At act 640, the process starts. The following acts may be implemented in any order.
At act 642, the display of the device, if equipped, is updated with the appropriate indication (e.g., go forward, go backward, turn left, turn right, etc.). See, e.g., FIGS. 3A-3G.
At act 644, the audio interface (and/or haptic interface) of the device is activated, if equipped.
At act 646, the last selected directional input from the baby is stored, then the process continues to act 648.
At act 648, the process ends.

### User Interface—“Yay!”—Adult Positive Feedback

The user interface on display 102 of device 100 is updated when the adult input device button 106 receives an input.

With reference to FIG. 2F, device 100 is depicted with adult input device 106 activated. In practice, the adult input device button is depressed by the finger of a caretaker to provide feedback to a baby. In some forms of the device, a positive reinforcement or “yay!” sound 230 (e.g., beeps, music notes, synthesized voice, recordings, etc.) may also be audibly produced by the device 100.

With refence to FIG. 3F, display 102 may be configured to display a positive reinforcement or yay indicator user interface element 320.

An adult may actuate button 106 to provide positive reinforcement when the baby successfully navigates to a desired location in the house (e.g., Let's go to Mom! *Baby navigates to mom*. Positive reinforcement is provided).

### User Interface—“Oh No!”—Adult Constructive or Corrective Feedback

The user interface on display 102 of device 100 is updated when the adult input device button 108 receives an input.

With reference to FIG. 2G, device 100 is depicted with adult input device 108 activated. In practice, the adult input device button is depressed by the finger of a caretaker to provide feedback to a baby. In some forms of the device, an error or “oh no!” sound 232 (e.g., beeps, music notes, synthesized voice, recordings, etc.) may also be audibly produced by the device 100.

With refence to FIG. 3G, display 102 may be configured to display an error or “oh no!” indicator user interface element 322.

An adult may actuate button 108 to provide an error tone when the baby needs a nudge to go in the right direction. For example, if the baby is navigating into a wall, an adult may press button 108 to provide the error sound 232 to the baby.

In various forms of the device, pressing button 108 may also cause the device 100 to ignore the baby input device until a new and different input is provided by the baby. For purposes of illustration and without limitation, the baby is navigating forward into a wall. Adult presses button 108 and the error tone is produced. Device 100 no longer accepts forward input from the baby until another input such as turn right, turn left, or backward is provided.

As another illustration and without limitation, the baby decided it is fun to spin to the left. After indulging the baby for a period of time, the adult is getting dizzy. The adult presses button 108 and the error tone is produced. Device 100 no longer accepts turn left input from the baby until another input such as turn right, forward, or backward is provided.

### User Interface—Adult Input Controls May Be Modified

Either of the positive and constructive feedback button may be removed, or both combined into one button. In some forms of the device, only one adult input button may be present. The button may trigger only one function or may trigger different functions depending on the length of time the button is pressed. For example, a short press may trigger an error tone, while a long press is configured to produce positive feedback.

### User Interface—Additional Inputs, Controls, and/or Functions

In various forms of the device, additional inputs may be present. Additional inputs or combinations of inputs may be added to the baby input area, the adult input area, or both.

For example, a switch, a lever, or other input device selected, designed, or sized for manipulation by an infant may be added to the baby input area. For purposes of illustration and without limitation the input may be a lever that can be put in an up position or a down position relative to the horizon. When the switch or lever is in the up position, the device 100 may indicate that the baby desires to be in a standing position. When the switch or lever is in the down position, the device 100 may indicate that the baby desires to be closer to the ground in a kneeling position.

As another example, an easy-to-press button other input device selected, designed, or sized for manipulation by an infant may be added to the baby input area. For purposes of illustration and without limitation, the input may be an arcade button or a button on or in the joystick that can be easily pressed by the infant. The infant may press the button to indicate something of interest to the caretaker/adult. For example:
if the infant navigates to an area near the changing pad and then indicates with the button, the child may desire to be changed;
if the infant navigates to an area his or her play pen and then indicates with the button, the child may desire to play with his or her toys in the play pen;
If the infant navigates to an area near his or her bottle washing station and then indicates with the button, the child may desire food.

As another example, a second joystick or a second device 100 may be coupled (e.g., wired, wirelessly, etc.) to the first device 100. For purposes of illustration and without limitation, the second joystick may be positioned to be operated by the infant's remaining free hand. The infant may manipulate the second joystick to implement additional commands such as:
Rotate to face upward (back j oystick)
Rotate to face downward (forward joystick);
Slide or shuffle left (left joystick); or,
Slide or shuffle right (right joystick).

These may be distributed or redistributed with existing commands across both joysticks. For example, one joystick could contain the commands:
Go forward (forward joystick)
Go backward (back joystick)
Turn or yaw left (left joystick)
Turn or yaw right (right joystick)

While the second joystick contains commands similar to the controls of an aircraft:
Tilt forward/rotate to face down (down elevator/forward joystick)
Tilt backward/rotate to face up (back elevator/back joystick)
Slide/shuffle/bank left (left joystick)
Slide/shuffle/bank right (right joystick)

As another example, foot controls may be coupled (e.g., wired, wirelessly, etc.) to the first device 100. The foot controls may be any type of sensor including accelerometers mounted on one or both feet, for example. For purposes of illustration and without limitation, the sensors may be placed in a sock, shoe or other device that straps to the child's foot. The infant may manipulate activate the foot controls by wiggling their respective foot:
Turn or yaw left (left foot wiggle);
Turn or yaw right (right foot wiggle).

While the joystick contains commands similar to the controls of an aircraft:
Tilt forward/rotate to face down (down elevator/forward joystick);
Tilt backward/rotate to face up (back elevator/back joystick);
Slide/shuffle/bank left (left joystick);
Slide/shuffle/bank right (right joystick).

In some forms of the device including an IMU 160, magnetometer 166, or other appropriate sensor, an infant can be exposed to the cardinal directions at an early age to help develop their sense of direction. For example, when moving forward, the device 100 can check the heading indicated by magnetometer, and within a threshold value of a cardinal or other direction (e.g., North, Northeast, East, South East, South, South West, West, North West, etc.), the device 100 may annunciate the name of the direction audibly with a synthesized voice, recording, or other audio.

Additional control configurations, inputs, and device functions are also possible.

### Methods

Following paragraphs are illustrations of various methods that may be implemented for one of many forms of the device, and may be adapted as necessary or appropriate for other forms of the device with additional or fewer inputs, functions, or capabilities. These are merely for purposes of illustration without limitation and therefore should not be used to limit the scope of any claimed invention.

The exemplary flowcharts presented throughout the patent disclosure may refer to software routines, or logical flows that are embodied in analog or other non-programmable hardware (e.g., digital logic, etc.).

### Methods—General Flowcharts

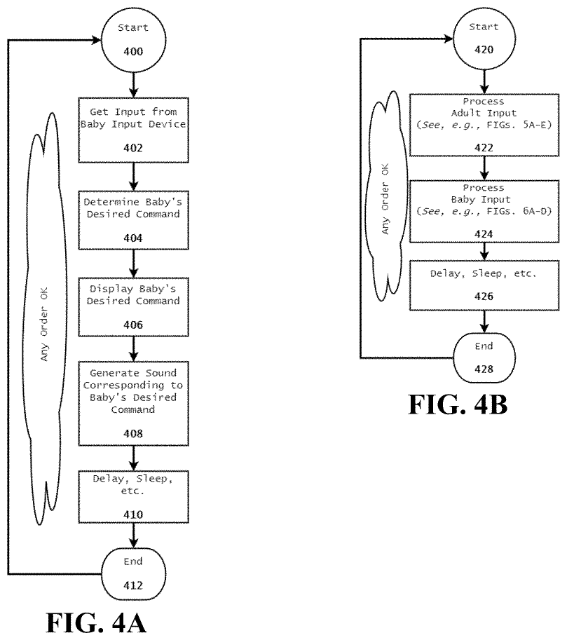

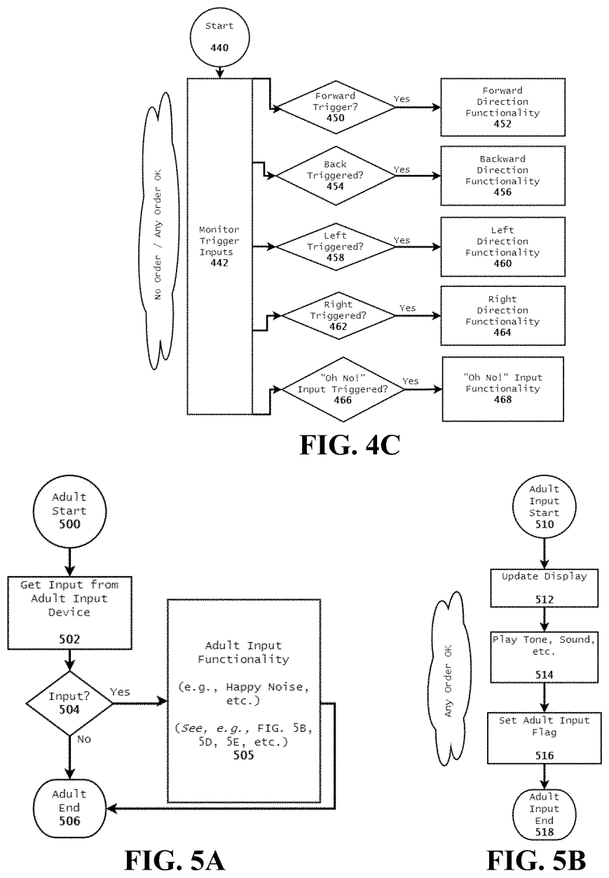

With reference to FIG. 4A, a simplified exemplary flowchart for the device operation is provided.
At act 400, the process starts. The following acts may occur in any order.
At act 402, the baby input device input is received from baby input device 104.
At act 404, the baby's desired command, if any, is determined.
At act 406, the user interface on the display 102 is updated to reflect the desired command.
At act 408, a sound corresponding to the baby's desired command may be produced in some forms of the device.
At act 410, there may be a delay before the end of the process at act 412.
After act 412, the process begins again at act 410.

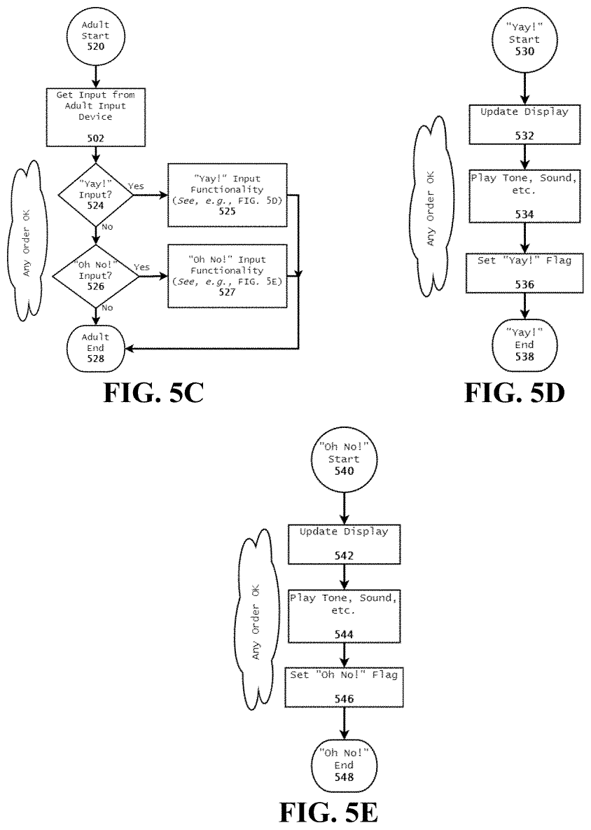

With reference to FIG. 4B, another simplified exemplary flowchart for the device operation is provided.
At act 420, the process starts. The following acts may occur in any order. At act 422, the adult input device is processed. See, e.g., FIGS. 5A-5E and the associated discussion below.
At act 424, the baby input device is processed. See, e.g., FIGS. 6A-6D and the associated discussion below.
At act 426, there may be a delay before the end of the process at act 428. The device may also enter a deep sleep mode to conserve battery.
After act 428, the process begins again at act 420.

With reference to FIG. 4C, another third simplified exemplary flowchart for the device operation is provided for some forms of the device (e.g. FIGS. 1K, 1N, etc.). The following acts may occur in any order or based on events or interrupts.
At act 440 the process starts, and trigger inputs are monitored at act 442.
   Act 450 occurs if the forward input is triggered and causes forward direction functionality 452 to activate.
   Act 454 occurs if the backward input is triggered and causes backward direction functionality 456 to activate.
   Act 458 occurs if the left input is triggered and causes left direction functionality 460 to activate.
   Act 462 occurs if the right input is triggered and causes right direction functionality 464 to activate.
   Act 466 occurs if the “oh no!” or constructive feedback input is triggered and causes “oh no!” or constructive feedback functionality 468 to activate.

### Methods—Adult Input Flowcharts

With reference to FIG. 5A, a simplified exemplary flowchart for processing adult input is provided.
At act 500, the process starts.
At act 502, the adult input is examined to determine if a an input is provided and the process proceeds to act 504.
At act 504, If no adult input was provided, then the process continues to act 506. If yes, then the process continues to act 505 where the adult functionality is executed. See, e.g., FIGS. 5B, 5D, 5E, etc.
At act 506, the process ends.

With reference to FIG. 5B, a simplified exemplary flowchart for activating a device function in response to adult input is provided.
At act 510, the process starts.
The following acts may be implemented in any order.
At act 512, the display of the device, if equipped, is updated.
At act 514, the audio interface (and/or haptic interface) of the device is activated, if equipped.
At act 516, an adult input flag may be set, if appropriate for the particular type of input. For example, if the adult input is corrective input, then a flag may be set to block the next baby input if it is the same as the last baby input. Then, the process continues to act 518.
At act 518, the process ends.

With reference to FIG. 5C, a simplified exemplary flowchart for processing adult input is provided.
At act 520, the process starts.
At act 502, the adult input is examined to determine if an input is provided. If adult input was provided, the process may proceed to act 524. Otherwise, the process may skip to act 528.
The following acts may occur in any order.
At act 524, If no adult input was provided, then the process continues to act 526. If an input was provided, then the process continues to act 525 where the adult positive feedback functionality is executed. See, e.g., 5D, etc.
At act 526, If no adult input was provided, then the process continues to act 528. If an input was provided, then the process continues to act 527 where the adult constructive feedback functionality is executed. See, e.g., 5E, etc.
At act 528, the process ends.

With reference to FIG. 5D, a simplified exemplary flowchart for activating a device positive reinforcement function in response to adult input is provided.
At act 530, the process starts.
At act 532, the display of the device, if equipped, is updated.
At act 534, the audio interface (and/or haptic interface) of the device is activated, if equipped.
At act 536, an adult input flag may be set, if appropriate for the particular type of input. For example, if the adult input is positive feedback input, then a flag may be set to increase a point value for a game on the device. Then, the process continues to act 538.
At act 538, the process ends.

With reference to FIG. 5E, a simplified exemplary flowchart for activating a device error function in response to adult input is provided.
At act 540, the process starts.
The following acts may be implemented in any order.
At act 542, the display of the device, if equipped, is updated.
At act 544, the audio interface (and/or haptic interface) of the device is activated, if equipped.
At act 546, an adult input flag may be set, if appropriate for the particular type of input. For example, if the adult input is corrective input, then a flag may be set to block the next baby input if it is the same as the last baby input. Then, the process continues to act 548.
At act 548, the process ends.

The corrective input may be automatically triggered in cases that are detected by device 100. For example, if the baby inputs a turn in same direction more than a number N times in a row or the average of the last M inputs indicates that the baby needs corrective input (e.g., based on an algorithm, neural network, etc.), it could indicate that the baby is lost, confused, or a control is stuck and the corrective input function may be triggered automatically.

### Example Physical Implementations

Numerous other implementations of the devices generally illustrated in FIG. 1A are possible using hardware configurations of varying complexity from analog only circuitry, digital circuitry, different microcontrollers, etc.

Following paragraphs are illustrations for various physical implementations of different forms of the device and methods. These are merely for purposes of illustration without limitation and therefore should not be used to limit the scope of any claimed invention. Furthermore, these various physical implementations may be adapted or combined in various ways as necessary or appropriate for other forms of the device with additional or fewer inputs, functions, or capabilities.

### Example Physical Implementation—M5Stick-C Implementation

With reference to FIG. 1B, a functional block diagram of a prototype form of device 100 that was constructed for testing is shown. In this particular form of the prototype, an M5Stick-C with integrated display and battery 120 was used as the main microcontroller module for the device 100. It was interfaced with an M5 SPK-HAT Speaker 122 in order to make noise, sounds, music, etc. In addition, the M5Stick-C 120 was interfaced with a baby input device (e.g., I2C Joystick Unit, etc.) 126 and Adult Input Device (e.g., Mini Dual Button Unit, etc.) 128 via Grove 1 to 3 Hub 124. Other devices, such as a vibration motor (not depicted), may also be connected to M5Stick-C via Grove 1 to 3 Hub 124.

With reference to FIGS. 9A-9D, a 3D printed frame or body 200 design used with the protype depicted in FIG. 1B is shown. With reference to FIG. 9A, a side view of a 3D printed frame or body 200 design is shown. From left to right, top to bottom, display area 202 is shown on the top left at 45-degree angle. Baby input area 204 is shown above the adult grip handle 206 of the frame, and adult input area on the front of the handle frame underneath the 45-degree angle. With reference to FIG. 9B, a back view of a 3D printed frame or body 200 design is shown. With reference to FIG. 9C, a front view of a 3D printed frame or body 200 design is shown. With reference to FIG. 9D, a perspective view of a 3D printed frame or body 200 design is shown. With reference to FIGS. 9E-9G, the completed prototype is illustrated with the various components depicted in FIG. 1B attached to the 3D printed frame or body 200 depicted in FIGS. 9A-9D. With reference to FIGS. 9E-9G, the constructed prototype device is shown. With reference to FIG. 9E, a side view of the prototype device is shown. With reference to FIG. 9F, a front view of the prototype device is shown. With reference to FIG. 9G, a back view of the prototype device is shown.

Example firmware source code for the example physical implementation based on the M5Stick-C is provided as “Code Table 1” and “Code Table 2” in U.S. Provisional Application 63/035,541, filed Jun. 5, 2020, are hereby incorporated by reference in its entirety for all purposes.

### Example Physical Implementation—Analog Implementation

In some forms of the device 100, analog circuitry may be utilized.

With reference to FIGS. 1C-H, an analog only circuit is shown implementing the invention. In this form, a battery 130, resistor(s) 332, light-emitting diodes (LEDs) 134a-f, and inputs 136a-f (e.g., buttons, d-pad, switches, etc.).

With reference to FIG. 1C, a simplified analog circuit diagram is shown for one form of the device. Display 133 may include simple display elements such as individual light emitting diodes (LEDS). Baby controls 135 may include one or more input devices 136a-d for directional input (e.g., buttons, d-pad, multi-way switch, joystick, etc.). For purposes of illustration and without limitation:
With reference to FIG. 1C, when baby input 136a, corresponding to a “go forward” command, is pressed, LED 134a corresponding to a “go forward” display may illuminate on display area 133.
With reference to FIG. 1D, when baby input 136b, corresponding to a “go backward” command, is pressed, LED 134b corresponding to a “go backward” display may illuminate on display area 133.
With reference to FIG. 1E, when baby input 136c, corresponding to a “turn right” command, is pressed, LED 134c corresponding to a “turn right” display may illuminate on display area 133.
With reference to FIG. 1F, when baby input 136d, corresponding to a “turn left” command, is pressed, LED 134d corresponding to a “turn left” display may illuminate on display area 133.

With reference to FIG. 1C, a simplified analog circuit diagram is shown for one form of the device. Adult controls 137 may include input devices 136e-f (e.g., buttons, d-pad, multi-way switch, joystick, etc.). For purposes of illustration and without limitation:
With reference to FIG. 1G, when adult input 136e, corresponding to a “positive feedback” command, is pressed, LED 134e corresponding to a “positive feedback” display may illuminate on display area 133. This LED may be a brighter or otherwise more eye-catching than other LEDs in order to be pleasing to the child.
With reference to FIG. 1H, when adult input 136f, corresponding to a “constructive feedback” command, is pressed, LED 134f corresponding to a “constructive feedback” display may illuminate on display area 133. This LED may be a brighter or otherwise more eye-catching than other LEDs in order to get the child's attention for corrective action.

This circuit may be modified to have an integrated circuit placed in between control inputs 135 and 137 and display area 133. Additionally, or alternatively, this circuit may be modified in order to have the adult controls 137 preempt the baby controls 135. The circuit may also be interfaced with additional hardware to make noises corresponding to each of the commands.

### Example Physical Implementation—Arduino Style Implementation

In some forms of the device, analog circuitry may be utilized with a microcontroller.

With reference to FIG. 1I, an example implementation of the device utilizing an “Arduino” or ATMEGA 328 microcontroller 140 and analog circuitry is depicted.

For purposes of illustration and without limitation, light-emitting diodes (LEDs) 134a-e may be the primary display of the device. Speaker or buzzer 142 may also be connected to the microcontroller. Baby input 143 may consist of a two-axis joystick (e.g., two orthogonal potentiometers 144a and 144b, etc.), or other input devices such as a 4- or 5-way switch. Adult input area may consist of a set of push buttons 136e and 136f.

For purposes of illustration and without limitation, with reference to FIG. 1I:
When the baby input, corresponding to a forward command, is provided (e.g., a resistance reading on an analog to digital converter (ADC) of the microcontroller 140 corresponding to a “go forward” deflection in either the 144a or 144b potentiometer, etc.), LED 134a corresponding to a “go forward” display may illuminate by activating the corresponding output on microcontroller 140. Microcontroller 140 may also generate a tone or series of tones to produce a “going forward” noise using speaker or buzzer 142.
When the baby input, corresponding to a backward command, is provided (e.g., a resistance reading on an analog to digital converter (ADC) of the microcontroller 140 corresponding to a “go backward” deflection in either the 144a or 144b potentiometer, etc.), LED 134b corresponding to a “go back” display may illuminate by activating the corresponding output on microcontroller 140. Microcontroller 140 may also generate a tone or series of tones to produce a “backing up” noise using speaker or buzzer 142.
When the baby input, corresponding to a turn right command, is provided (e.g., a resistance reading on an analog to digital converter (ADC) of the microcontroller 140 corresponding to a “turn right” deflection in either the 144a or 144b potentiometer, etc.), LED 134c corresponding to a “turn right” display may illuminate by activating the corresponding output on microcontroller 140. Microcontroller 140 may also generate a tone or series of tones to produce a “turning right” noise using speaker or buzzer 142.
When the baby input, corresponding to a turn right command, is provided (e.g., a resistance reading on an analog to digital converter (ADC) of the microcontroller 140 corresponding to a “turn left” deflection in either the 144a or 144b potentiometer, etc.), LED 134d corresponding to a “turn left” display may illuminate by activating the corresponding output on microcontroller 140. Microcontroller 140 may also generate a tone or series of tones to produce a “turning left” noise using speaker or buzzer 142.
When the adult input, corresponding to a positive feedback command, is provided (e.g., a low or high voltage on the pin of the of the microcontroller 140 corresponding to the 136e input, etc.), LED 134e corresponding to a “positive feedback” display may illuminate by activating the corresponding output on microcontroller 140. Alternatively, additional or all of the LEDs may be illuminated in any manner (e.g., solid, pattern, animation, etc.) in response to the adult input. Microcontroller 140 may also generate a tone or series of tones to produce a “positive feedback” noise using speaker or buzzer 142.
When the adult input, corresponding to a constructive feedback command, is provided (e.g., a low or high voltage on the pin of the of the microcontroller 140 corresponding to the 136f input, etc.), LED 134f corresponding to a “constructive feedback” display may illuminate by activating the corresponding output on microcontroller 140. Alternatively, additional or all of the LEDs may be illuminated in any manner (e.g., solid, pattern, animation, etc.) in response to the adult input. Microcontroller 140 may also generate a tone or series of tones to produce a “constructive feedback” noise using speaker or buzzer 142.

Example firmware source code for the example physical implementation based on the ATMEGA 328 (or compatible/similar) is provided as “Code Table 3” and “Code Table 4” in U.S. Provisional Application 63/035,541, filed Jun. 5, 2020, are hereby incorporated by reference in its entirety for all purposes.

### Example Physical Implementation—ATTINY Implementation

With reference to FIGS. 1J and 1M, implementations of the device utilizing an ATTINY “Arduino” or ATMEGA microcontroller 150 and analog circuitry is depicted.

For purposes of illustration and without limitation, an OLED graphic display 154 may be the primary display of the device. Speaker or buzzer 152 may also be connected to the microcontroller. Baby input 153 may consist of a 5-way switch (as shown in FIG. 1J), a two axis potentiometer joystick (as shown in FIG. 1M), or any other type of input device. Adult input area, if present, may consist of one or more inputs (e.g., button or switch 158).

For purposes of illustration and without limitation, with reference to FIG. 1J:
When the baby input, corresponding to a forward command, is provided (e.g., a voltage/current/resistance reading on an analog to digital converter (ADC) of the microcontroller 150 corresponding to a “go forward” input (e.g., the voltage drop across the 8.2k resistor R4, etc.)), a graphic OLED indication corresponding to a “go forward” display may illuminate by activating the SDA and SCL outputs appropriately on microcontroller 150. Microcontroller 150 may also generate a tone or series of tones to produce a “going forward” noise using speaker or buzzer 152.
When the baby input, corresponding to a backward command, is provided (e.g., a resistance reading on an analog to digital converter (ADC) of the microcontroller 150 corresponding to a “go backward” input (e.g., the voltage drop across the 3.9k resistor R5, etc.)), a graphic OLED indication corresponding to a “go backward” display may illuminate by activating the SDA and SCL outputs appropriately on microcontroller 150. Microcontroller 150 may also generate a tone or series of tones to produce a “going backward” noise using speaker or buzzer 152.
When the baby input, corresponding to a forward command, is provided (e.g., a resistance reading on an analog to digital converter (ADC) of the microcontroller 150 corresponding to a “turn left” input (e.g., the voltage drop across the 20k resistor R7, etc.)), a graphic OLED indication corresponding to a “turn left” display may illuminate by activating the SDA and SCL outputs appropriately on microcontroller 150. Microcontroller 150 may also generate a tone or series of tones to produce a “turning left” noise using speaker or buzzer 152.
When the baby input, corresponding to a forward command, is provided (e.g., a resistance reading on an analog to digital converter (ADC) of the microcontroller 150 corresponding to a “turn right” input (e.g., the voltage drop across the 2k resistor R6, etc.)), a graphic OLED indication corresponding to a “turn right” display may illuminate by activating the SDA and SCL outputs appropriately on microcontroller 150. Microcontroller 150 may also generate a tone or series of tones to produce a “turning right” noise using speaker or buzzer 152.
When the adult input, corresponding to for example a positive or constructive feedback command, is provided (e.g., a low voltage on the pin of the of the microcontroller 150 corresponding to the PB1 input, etc.), a graphic OLED indication corresponding to a “positive feedback” or “constructive feedback” display may illuminate by activating the SDA and SCL outputs appropriately on microcontroller 150. Microcontroller 150 may also generate a tone or series of tones to produce a “constructive feedback” noise using speaker or buzzer 152.

For purposes of illustration and without limitation, with reference to FIG. 1M:
When the baby input, corresponding to a forward command, is provided (e.g., a voltage/current/resistance reading on an analog to digital converter (ADC) of the microcontroller 150 corresponding to a “go forward” input, a graphic OLED indication corresponding to a “go forward” display may illuminate by activating the SDA and SCL outputs appropriately on microcontroller 150. Microcontroller 150 may also generate a tone or series of tones to produce a “going forward” noise using speaker or buzzer 152.
When the baby input, corresponding to a backward command, is provided, a graphic OLED indication corresponding to a “go backward” display may illuminate by activating the SDA and SCL outputs appropriately on microcontroller 150. Microcontroller 150 may also generate a tone or series of tones to produce a “going backward” noise using speaker or buzzer 152.
When the baby input, corresponding to a forward command, is provided, a graphic OLED indication corresponding to a “turn left” display may illuminate by activating the SDA and SCL outputs appropriately on microcontroller 150. Microcontroller 150 may also generate a tone or series of tones to produce a “turning left” noise using speaker or buzzer 152.
When the baby input, corresponding to a forward command, is provided, a graphic OLED indication corresponding to a “turn right” display may illuminate by activating the SDA and SCL outputs appropriately on microcontroller 150. Microcontroller 150 may also generate a tone or series of tones to produce a “turning right” noise using speaker or buzzer 152.
When the adult input, corresponding to for example a positive or constructive feedback command, is provided, a graphic OLED indication corresponding to a “positive feedback” or “constructive feedback” display may illuminate by activating the SDA and SCL outputs appropriately on microcontroller 150. Microcontroller 150 may also generate a tone or series of tones to produce a “constructive feedback” noise using speaker or buzzer 152.

Example firmware source code for the example physical implementation based on the ATTINY corresponding to FIGS. 1M and 13A-E is provided below:

In various forms of this implementation or other implementations of the device, the display 102 on the top of the device 100 may have the graphic OLED display 154 forward of the baby input device 153. In other forms of this or other implementations of the device, discrete LEDs may be used for the display 102. Still, in other forms of this or other implementations of the device, the device may omit any type of display 102 and indicate directional commands input by the baby via input device 153 by sound via speaker or buzzer 152.

In other forms of device 100:
PB5 and PB3 may be connected to the X and Y axis of a dual-axis thumb stick or joystick that serves as baby input 104.
PB4 may be connected to a speaker or buzzer.
SCL and SDA may be connected to a display.
PB1 may be connected to a button that serves as adult input.
   PB1 may be configured as an interrupt.
   The button may be configured to implement different actions based on the type of press:
      Short press
      Long press
      Single press
      Multiple press
      Etc.

### Example Physical Implementation—AM4EC Implementations

With reference to FIG. 1K, the device 100 may be implemented with a AM4EC style microcontroller (or any other “voice” or “audio” integrated circuit; see e.g., FIG. 1N). In some forms of the device using this microcontroller, charlieplexed LEDs may be implemented so that 6 LED lights can be controlled with three output pins on the microcontroller. Alternatively, the user interface may omit the LEDs and rely solely on a sound making device for output. The microcontroller may also be interfaced with a speaker and several inputs such as a directional input (e.g., D-Pad, Joystick, etc.) and optionally an adult input device. Alternatively, a 16-pin chip may be used (see, e.g., FIG. 1N).

The display of the device 100 in various forms of this form of the invention may include a cross-shaped configuration for the LEDs on the display 102 of the device. Positive and corrective feedback LEDs may be placed in the center of the cross. Baby input is located behind the display 102. Adult inputs(s), if present, may be located on the back of the device, trigger area of the device, etc.

### Example Physical Implementation—16-Pin Voice and/or Audio Chip

With reference to FIG. 1N, U1 is a 16-pin Microcontroller and/or Voice and/or Audio Chip. C1 and C2 are capacitors that smooth the power between U1 Pins 1 and 15. Areas marked TG1, TG2, TG3, TG4, TG5 are “Triggers” or Switches. TG1 is the Backward Baby Input and is connected to the 16-pin SOC U1 at Pin 11. TG2 is the Left Baby Input and is connected to U1 at Pin 12. TG3 is the Forward Baby Input and is connected to U1 at Pin 13. TG4 is the Right Baby Input and is connected to U1 Pin 14. TG5 is the Corrective Feedback or “Uhoh” Adult Input Button and is connected to U1 at Pin 10. Areas marked L1, L2, L3, L4, L5 are light emitting diodes (LEDs). L1 is the Backward Indicator LED and is connected to U1 at Pin 6. L2 is the Left Indicator LED and is connected to U1 at Pin 5. L3 is the Forward Indicator LED and is connected to U1 at Pin 4. L4 is the Right Indicator LED and is connected to U1 at Pin 3. L5 is the Corrective Feedback or “Uhoh” Indicator LED and is connected to U1 at Pin 7. The area marked “SPK” are the Speaker Connections which are connected to U1 at Pins 2 and 16. The area marked “+BT-” are the Battery Connections which are connected to U1 at Pins 1 and 15. When TG1 is “triggered” or pressed, microchip U1 activates LED light L1 and plays a “go backwards” sound via the speaker output. When TG2 is “triggered” or pressed, microchip U1 activates LED light L2 and plays a “turn left” sound via the speaker output. When TG3 is “triggered” or pressed, microchip U1 activates LED light L3 and plays a “go forward” sound via the speaker output. When TG4 is “triggered” or pressed, microchip U1 activates LED light L4 and plays a “turn right” sound via the speaker output.

### Example Physical Implementation—TTGO-TS Implementation

With reference to FIG. 1L, the device 100 may be implemented with a ESP32 style microcontroller or development module such as a TTGO TS V1.4 development board including a TFT LCD with Speaker and other features. The microcontroller may also be interfaced with a speaker and several inputs such as a directional input (e.g., D-Pad, Joystick, etc.) and optionally an adult input device. For example, IO26 and IO27 are ADC2:9 and ADC2:7, respectively. Therefore, the X and Y axis of a dual 10k potentiometerjoystick could be hooked to those IO pins on the TTGO TS. Other inputs may be used for buttons relating to adult input. The built-in speaker and TFT LCD screen may be used as output devices. The built in battery charging circuit may be utilized as a power source when coupled with a LiPo battery via micro JST plug. The SD Card reader may be used to load and save configuration files (or this may be done on the internal memory of the ESP32). The SD Card reader may be used to store other media (e.g., customized or other logo, forward, backward, left, right, positive feedback, corrective feedback assets including images and sound information).

### Example Physical Implementation—Radio Beacon Implementation

In some forms of the device, a radio beacon (e.g., Bluetooth Low Energy Beacon, etc.) with IMU embedded into a baby input device may be paired with a smart phone or other device to implement the features of the invention.

In various forms of this implementation of the device, the radio beacon is mounted in a joystick type device that is designed to be manipulated by a baby. For example, as a prototype, a pop-socket style phone holder may be used to mount the beacon (e.g., a Texas Instruments SensorTag with MPU-9250 IMU). In practice, an appropriately sized plastic or other material j oystick would be crafted on/in which to house or mount the beacon.

The beacon is then paired with an app on a mobile device. The app on mobile device receives signals from BLE beacon (either attitude or an encoded directional input based on the attitude determined by the IMU). The app on the mobile device then renders the display on the mobile device to indicate whether the beacon, mounted in/on the baby input device, is vertical (no input), forward (titled forward), backward (tilted backward), turn right (tilted right), or turn left (tilted left). The beacon may also have buttons that serve as an adult input device, or it may be configured to sense tapping input via an accelerometer as a way to trigger an adult input such as a corrective feedback input.

### Example Physical Implementation—Smart Phone or Tablet Implementation

In some forms of the device, an application is downloaded to a smart phone. The application displays a baby input area including directional buttons, along with an output area that displays the input received by the baby. The application also has an optional adult input button display in a separate area of the screen.

In various forms of this implementation of the device, a phone case with a handle may be used with the phone to assist with holding the phone in the proper orientation to use the application with an infant. In addition, optionally a Bluetooth trigger is paired to the phone and mounted in the case. Still further, in some forms of this device, a baby joystick that interfaces with the appropriate touch sensitive targets on the screen may be provided that snaps onto the case or otherwise sits over the touch display panel in the appropriate area to allow the baby to actuate the touch targets in the baby input area utilizing the joystick device.

### Example Physical Implementation—Other Implementations

In some forms of the device, any other type of circuitry may be used. The device, methods, and systems described herein can be implemented in any type of hardware or circuitry known or yet to be developed including: analog, analog or digital transistor circuitry, digital logic circuitry, Field Programmable Gate Array (FPGA) circuitry, Application Specific Integrated Circuit (ASIC), Microcontroller, CPU, or any other type of circuitry. Some additional example implementations are provided herein further illustration.

### Methods of Use—Generally

The devices, systems and methods may be used in many different ways.

In some forms, the devices, systems and methods may be used by the infant without an adult. For example, In some forms of the devices, systems and methods, the device may have a mode where it entertains baby by playing sounds, animations, educational material, or other content when the baby is using the device without a caretaker. As another example, in some forms of the devices, systems, and methods, the device may have a mode where it controls a mobility device (a motorized base that securely holds the baby and can move as specified) and it can be used by the infant alone (e.g., with adult supervision, etc.).

In other forms of the devices, systems and methods, the device is used simultaneously by the infant and the adult.

### Methods of Use—Training the Infant to Use the Devices, Systems, and Methods

Initially, an infant may need to be trained to use the device. The caretaker may train the infant to use the device 100 using the caretaker's thumb.

The caretaker, holding the infant against his or her chest (or having the infant held with a harness like an Ergobaby harness or similar), with the infant facing forward, the caretaker can place his or her hand next to the baby with the caretaker's thumb extended upward. The baby can then be directed to grab the caretaker's thumb. The caretaker can then train the baby to utilize its hands to express a desired direction to move in the environment. For example:
The caretaker can, by moving his or her thumb forward and walking forward, demonstrate to the baby that when the baby's hand moves forward (e.g., simulating the baby moving the thumb forward, etc.), it move the thumb forward and the caretaker moves forward. Thus, the baby is able to move forward through its environment.
Similarly, the caretaker can, by moving his or her thumb backward and walking backward, demonstrate to the baby that when the baby's hand moves backward (e.g., simulating the baby moving the thumb backward , etc.), it move the thumb backward and the caretaker moves backward. Thus, the baby is able to move backward through its environment.
Similarly, the caretaker can, by moving his or her thumb right and slowly rotating right, demonstrate to the baby that when the baby's hand moves right (e.g., simulating the baby moving the thumb right, etc.), it move the thumb right and the caretaker turns right. Thus, the baby is able to turn to the right in its environment.
Similarly, the caretaker can, by moving his or her thumb left and slowly rotating left, demonstrate to the baby that when the baby's hand moves left (e.g., simulating the baby moving the thumb left, etc.), it move the thumb left and the caretaker turns left. Thus, the baby is able to turn to the left in its environment.

Once the infant has been sufficiently exposed to this process, the caretaker's thumb may be substituted with the baby input 104 of device 100. The caretaker can then observe the display 102 of device 100 and/or listen to the audio produced by device 100 based on the baby's manipulation of baby input 104. The caretaker can then walk in the direction indicated by the baby via the output of device 100.

### Methods of Use—Free Form Exploration or Communication Tool

In some forms, the device may be used by the baby and caretaker to simply explore an environment, or for the baby to communicate desires/needs to the caretaker.

With reference to FIG. 10E, a caretaker may hold an infant facing forward, while the infant grips the baby input and the caretaker holds the adult grip of the device 100.

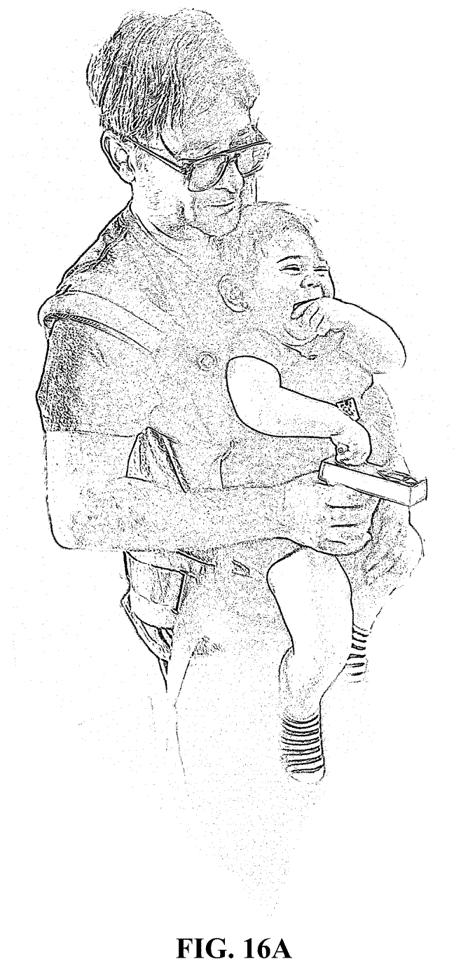

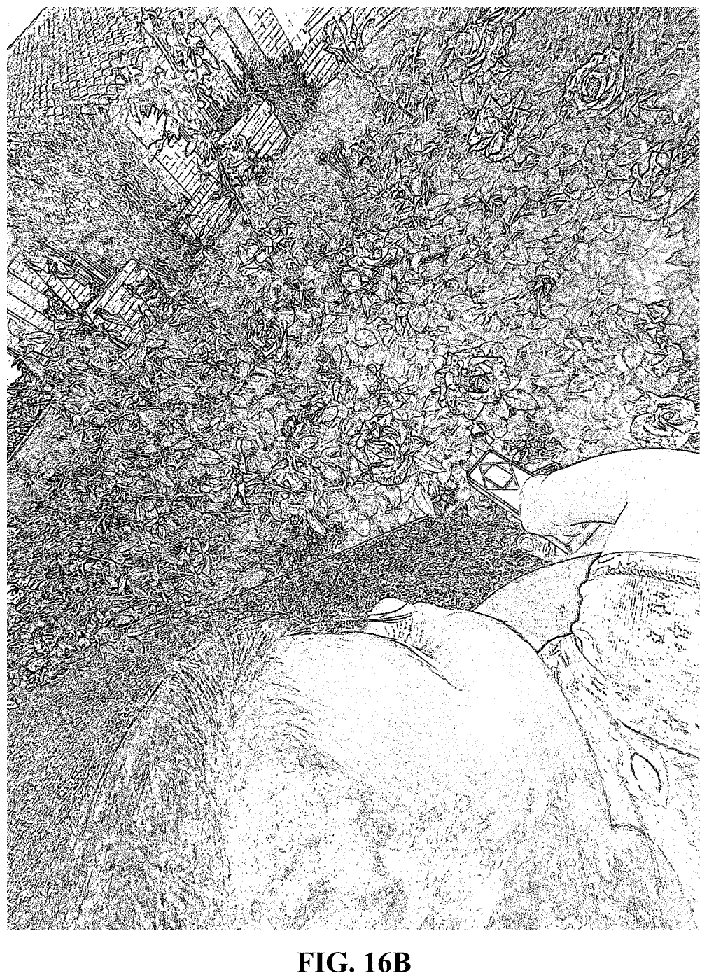

With reference to FIGS. 10F, 10G, and 16A, a caretaker may wear the infant facing forward using a device such as an Ergobaby harness while the infant grips the baby input device and the caretaker holds the adult grip of device 100.

With reference to FIGS. 16A and 16B, while the baby manipulates the baby input device, the caretaker observes the display of device 100 and moves as directed by the baby. With respect to FIG. 16A, the caretaker observes the display of device 100 over the infant's shoulder. FIG. 16B provides the adult caretaker perspective view of one form of the device while wearing an infant. FIGS. 10A-D illustrate one form of the device displaying commands to the caretaker in response to the baby's input.

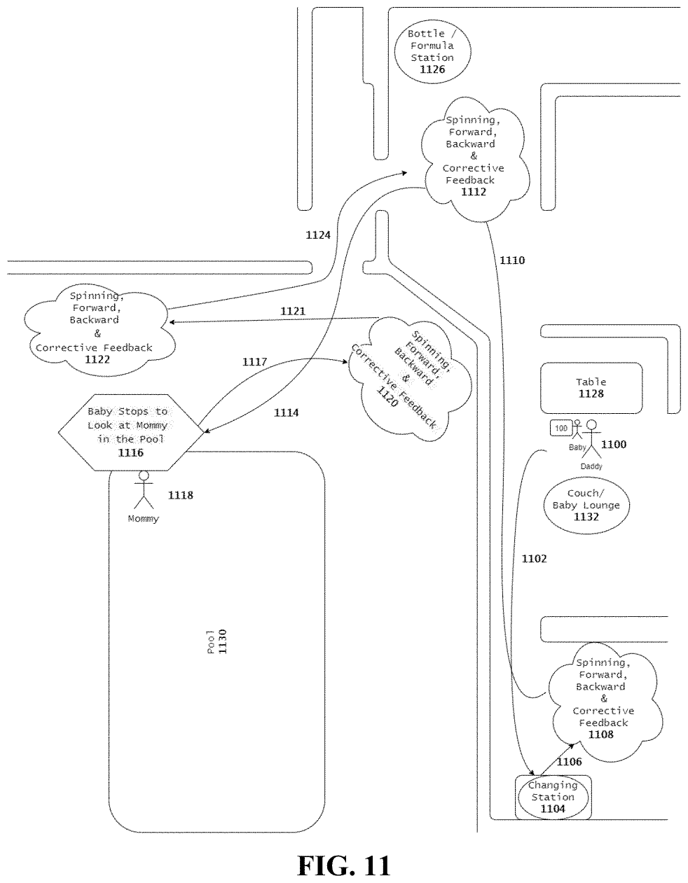

For purposes of illustration and without limitation, FIG. 11 shows an environment based on the area in which the prototype device 100 (see, e.g., FIGS. 1B, 9A-9G, 13A-E, 15A-H, 10A-10D, 16A-B, etc.) was tested with a 3- to 4-month-old infant. The following description is based on one of many experiments conducted with the infant.
At location 1100 caretaker picks up baby and device 100 from the baby lounge area 1132.
Baby manipulates the controls of device 100 to first direct the caretaker toward the wall then turns left and directs caretaker forward until arriving at changing station 1104 along path 1102.
The caretaker then changes the baby at changing station 1104 after discovering that the baby did in fact need to be changed. The caretaker again picks up baby and device 100 from the changing station 1104.
Baby directs caretaker along path 1106 and begins seemingly randomly exploring, spinning left and right, and moving forward and backward in area 1108. While exploring area 1108, the baby noticed a basket of new stuffed animal toys and spun around near basket before stopping to observe the new toys for a period of time. Then, baby continues to explore. When baby inputs too many consecutive turning left or right commands or gets stuck going forward or backward into obstacles, caretaker provides corrective feedback input to redirect the baby.
Next, baby manipulates baby input 104 of device 100 to navigate along path 1110 to area 1112. Baby continues to explore area 1112. When baby inputs too many consecutive turning left or right commands or gets stuck going forward or backward into obstacles, caretaker provides corrective feedback input to redirect the baby.
Baby next navigates along path 1114 to exit the house to the backyard area with pool 1130 where the baby's mother 1118 is swimming; baby stops at location 1116 to observe his mother 1118 for a period of time.
Next, baby manipulates baby input 104 of device 100 to navigate along path 1117 to area 1120. Baby continues to explore the backyard area 1120 and occasionally stops and turns to observe his mother 1118 from a distance. When baby inputs too many consecutive turning left or right commands or gets stuck going forward or backward into obstacles, caretaker provides corrective feedback input to redirect the baby.
Next, baby manipulates baby input 104 of device 100 to navigate along path 1121 to area 1122. Baby continues to explore the backyard area 1122 by going forward and backward exploring the running pool pump at the end of the wall.
Next, baby manipulates baby input 104 of device 100 to navigate along path 1124 to go back inside the house.

From the above example, the baby was able to explore its environment even though unable to crawl. The baby was able to express its needs (e.g., for a change) by navigating to the changing table. The baby was able to investigate items of interest to it (e.g., the toy bin), and go to and look at his mother.

### Methods of Use—Single Baby Games

In some forms, the device 100 may be used by the baby and caretaker to play a game in an environment. In variations of this form of the invention, the device may further include a scoring mechanism or a game rules mechanism in the form of a point system or other algorithm programmed into the microcontroller or designed into the circuitry. The game may be either orally administered by the caretaker, activated on the device as a program, or a combination of both. The game system aspects may also be interfaced with the adult input buttons and/or an IMU or other sensor, if the device is equipped, to aid in scoring or enforcing game rules.

Methods of Use—Single Baby Games—Go to or Find X Game. For purposes of illustration and without limitation, one game that may be played is one where the baby is challenged by the caretaker to go to a location in the house or find an object (e.g., Caretaker: “Baby, let's go to the kitchen!”, etc.). The baby can then be given baby input 104 of device 100, and the caretaker may follow the directions provided by the baby via display 102. To the extent the baby gets stuck or needs assistance, corrective input may be actuated by the caretaker. In variations of the device 100 with a scoring system, when the baby reaches a goal the positive reinforcement input may add points to a score associated with the baby or the particular instance of the game. Similarly, in variations of the device with a scoring system, the corrective input from the adult may deduct from the baby's score for the game or may be otherwise limited during the course of the game.

Methods of Use—Single Baby Games—Hide and Go Seek. For purposes of illustration and without limitation, another game that may be played is one where the baby is challenged by the caretaker to find an object that has been hidden or a person that is hiding (e.g., Caretaker (after hiding stuffed dinosaur): “Let's find where your stuffed dinosaur went!”, Dad (after Mother goes off to a different part of the house): “Let's go find mommy!,” etc.). The baby can then be given baby input 104 of device 100, and the caretaker may follow the directions provided by the baby via display 102. To the extent the baby gets stuck or needs assistance, corrective input may be actuated by the caretaker. In variations of the device 100 with a scoring system, when the baby finds the hidden object or person the positive reinforcement input may add points to a score associated with the baby or the particular instance of the game. Similarly, in variations of the device with a scoring system, the corrective input from the adult may deduct from the baby's score for the game or may be otherwise limited during the course of the game.

Methods of Use—Single Baby Games—Race Through House. For purposes of illustration and without limitation, another game that may be played is one where the baby is challenged by the caretaker to take a specific path through the house. The device 100 may be used alongside or bundled with printed educational targets such as cards or posters with the ABC's, numbers, colors, illustrations of items (e.g., baby bottle, diaper, bear, dinosaur, rocket, emoji's, etc.) or other educational content. There may also be targets that serve as places to avoid that result in point deductions in certain variations of the game. These targets can be set up throughout the house (e.g., A in the living room, B in the bedroom, C in the kitchen, etc.) and the baby can be challenged to complete the course by the caretaker one object at a time (e.g., “Let's find A and avoid monsters!”, etc.), or as a group (e.g., “Let's go to A then B then C! Watch out for monsters and stay away!”, etc.). The baby can then be given baby input 104 of device 100, and the caretaker may follow the directions provided by the baby via display 102. To the extent the baby gets stuck or needs assistance, corrective input may be actuated by the caretaker. In variations of the device 100 with a scoring system, when the baby finds the next object along the course, positive reinforcement input may add points to a score associated with the baby or the particular instance of the game. Similarly, in variations of the device with a scoring system, the corrective input from the adult may deduct from the baby's score for the game or may be otherwise limited during the course of the game. Corrective input may also be actuated upon encountering a target to avoid during the course of a game, in variations of the game.

Methods of Use—Single Baby Games—Specialized Games. Specialized games may also be developed of varying complexity. As children age and become accustomed to using the disclosed devices, systems and methods, other variations of using the device can keep the infant engaged. As such, a parent who has a very specific hobby such as sailboat racing or flying sailplanes may want to share that love with their baby from an early age before the baby would otherwise be able to enjoy the hobby.

Methods of Use—Single Baby Games—Specialized Games—Sailplane Game. For purposes of illustration and without limitation, another game that may be played is one where the baby is challenged by the caretaker to “fly a glider” around a path through the house. The device 100 may be used alongside or bundled with printed educational targets such as cards or posters with items relating to the hobby.
There can be goals or turn points (e.g., images of airports from the sky with the airport name, images of towns, or other images related to “turn points”, etc.).
There can be targets that are associated with positive items or power ups or point increases (e.g., a towplane, a puffy cumulus cloud with a thermal underneath, a mountain ridge with wind for ridge lift,” a lenticular cloud with wave lift, and other images representing different forms of “lift”, etc.).
There may also be targets that serve as places to avoid that result in point deductions in certain variations of the game (e.g., a dissipating cloud, a thunderstorm, and other images representing forms of “sink”, etc.).
Targets or goals can be set up throughout the house (e.g., Marfa, TX Airport in the living room, Upton County, TX Airport in the bedroom, Van Horn, TX Airport in the kitchen, etc.). Power ups can be placed along the desired route (e.g., puffy cumulus clouds and other “lift” targets, etc.) and areas to avoid (e.g., “sink” targets, etc.) off the course.

For purposes of illustration and without limitation, the baby can be challenged to complete the course by the caretaker one object at a time (e.g., “We are at Marfa airport lets go to Upton County! Watch your altitude and if we need to go higher get lift, and let's try to avoid sink!”, etc.), or as a group (e.g., “We are at Marfa. First let's go to Upton County then Van Horn then back to Marfa! We will need to find lift along the way and lets watch out for sink!”, etc.).
The baby can then be given baby input 104 of device 100, and the caretaker may follow the directions provided by the baby via display 102.
In this variation of the game, points may be associated with or synonymous to the altitude of a glider.
The game may start with a given optionally configurable number of points (e.g., 2000, etc.) to simulate being released by a towplane over the original airport.
Moving forward, backward, and turning may deduct the points at a set by relatively slow rate that is optionally configurable for the game (e.g., −200 points per Y inputs) (e.g., to simulate the glide ratio of a glider, etc.).
If the baby encounters a “sink” target, corrective reinforcement input may deduct points from an altitude score for the baby in the game at a faster than normal rate (e.g., −1000 points per Y or Z inputs, etc.).
When the baby finds a “lift” target, positive reinforcement input may add points to an altitude score for the baby in the game at an optionally configurable rate (e.g., +400 points per X inputs, etc.).
   The baby may be required to circle or spin left or right near the “lift” target to obtain the maximum benefit of the lift to maximize the input while in the proximity of the “lift” target. In variations of this aspect, the adult may activate positive reinforcement button to add points/altitude to the baby's score while the baby is turning. Multiple positive reinforcement presses may be permitted over a period of time, but they also may be limited to keep the game challenging.
   In some variations of this aspect of the invention, in forms of the device 100 with an IMU/accelerometer/gyro/mag, the game may be programmed to require spinning to be verified by the IMU/accelerometer/gyro/mag or other sensor in the device 100.
When the baby finds the next goal target along its course (e.g., “Upton County, TX Airport”, etc.), then it may be prompted to continue on to the next airport. Points/altitude may be awarded for reaching the goal, or goals may not award points.
If the score goes to zero before reaching the original airport at the end of the course, the game may be over due to the baby “landing out” between airports and without completing the course. Alternatively, the caretaker may inform the baby and add additional points to help the baby continue on the game.
If the baby is able to complete the course and reach the original airport with score remaining, then the remaining score may be recorded. In variations of the game, the best score may be based on the time to complete the course. In variations of the game, the smallest positive score may be considered the best, while in other variations of the game the largest positive score upon completion may be considered the best. Still in other variations of the game the best result may be a combination of time to complete the course and score.

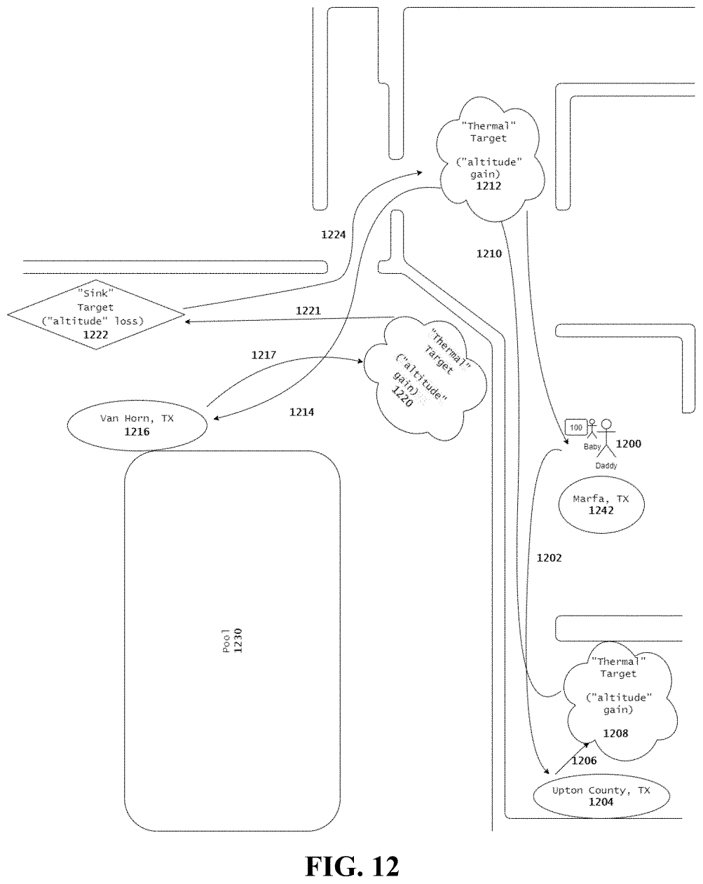

For purposes of illustration and without limitation, FIG. 12 shows an example session of a gliding game.
At location 1200 caretaker picks up baby and device 100 from the baby lounge area 1132 which for purposes of this game has been designated as the goal airport of Marfa, Tex. 1242. The baby starts with 2000 points.
Baby manipulates the controls of device 100 to first direct the caretaker toward the wall then turns left and directs caretaker forward until arriving at changing station 1104 which has been designated as the next goal, Upton County, TX, 1204 along path 1202. The points decrease at a rate of −200 points per 10 inputs. At a safe walking speed, it took 25 inputs to get to the Upton County, TX, target 1204 and baby has 1500 points left.
Baby directs caretaker along path 1206 to a “thermal” target 1208 loosing another 100 points (1400 points left) and begins spinning right near the target 1208. Adult caretaker activates the positive feedback input to increase baby's points by +400 points per 8 inputs while the audio user interface may beep happily (like that of a variometer in lift). After a few 360 degree turns baby's points have increased by +1200 and baby now has 3600 points.
Next, baby manipulates baby input 104 of device 100 to navigate along path 1210 taking 35 inputs and losing 700 points (2900 points left) to another “thermal” target area 1212. Baby ignores the thermal target and continues along path 1214.
Baby next navigates along path 1214 to exit the house to the backyard area with pool 1230. This took another 25 inputs reducing the baby's points by 500 (2400 points left). Baby stops at location 1216 which was designated as the Van Horn, Tex. goal 1216 for this game.
Next, baby manipulates baby input 104 of device 100 to navigate along path 1217 to thermal target area 1220 loosing another 200 points (2200 points left) and begins spinning left near the target 1220. Adult caretaker activates the positive feedback input to increase baby's points by +400 points per 8 inputs. After a handful of 360 degree turns baby's points have increased by +1600 and baby now has 3800 points.
Next, baby manipulates baby input 104 of device 100 to navigate along path 1221 to “sink” target area 1222 losing 200 points en route (3600 points left). Adult caretaker activates the constructive feedback input to decrease baby's points by 1000 points per 10 inputs. The sound user interface of device 100 makes a sad beeping tone (like that of a variometer in sink) and baby immediately reverses only losing 300 points while near the sink (3300 points left).
Next, baby manipulates baby input 104 of device 100 to navigate along path 1224 to go back inside the house to “thermal” target 1212. This takes another 25 inputs (2800 points left). This is enough points to get back to Marfa, Tex. 1242 so baby does not circle near the thermal target and proceeds back to location 1200 near the goal target of Marfa, Tex. 1242.
Baby completed the game!
Variations of the game that are more or less formal (e.g., more or less rules) are also contemplated depending on the age and understanding of the rules grasped by the infant.

Methods of Use—Single Baby Games—Custom Games. Other specialized or customized games may be created, rules written, and if necessary, programmed into the device. Third party customized games may be loaded into the device via a communication interface (e.g., USB, SD Card, Wi-Fi, Bluetooth, etc.)

Methods of Use—Single Baby Games—User Profile and Scoring System. The device 100 may have multiple baby user profiles for households with multiple babies. Scores can be stored in a way associated with the appropriate baby profile. The device may also incorporate a leaderboard in the device so that scores for one or all of the users can be compared over time. This may also be interfaced with an online backend to facilitate sharing of scores online, in forms of device 100 that include communications interfaces that can connect to or be relayed to the internet.

### Methods of Use—Multi-Baby Games

The above-mentioned games can be utilized with one caretaker and one baby. They may also be utilized with multiple caretakers, multiple babies, and multiple device 100s. Multiple babies can be given the same challenges and their performance compared to determine a “winner” for the game.

### Methods of Use—Other Uses

In various forms of the devices systems and methods, the device 100 may be utilized as a controller for a radio-controlled car or device with parental override/brake. For example, the baby input 104 may be configured to wirelessly control a vehicle while adult input (e.g., the corrective input) is configured to act as a break or cut off for the baby's control of the vehicle.

### Methods of Use—Conclusion

Aspects of the above use cases can be combined and modified in any possible combinations and permutations. Numerous other potential uses and game variations may be used with the devices systems and methods disclosed herein.

### Conclusion

As those skilled in the art will appreciate, many aspects of the invention, and the various forms of the invention, can beneficially be practiced alone and need not be coupled together. Unless specifically stated otherwise, no aspect of the invention should be construed as requiring combination with another aspect of the invention in practice. However, those skilled in the art will also appreciate that the aspects of the invention may be combined in any way imaginable to yield one of the various forms of this invention.

Various alterations and changes can be made to the above-described embodiments without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

I claim:

1. A device comprising:
a) a body including:
i) a substantially vertical handle sized to be used by an adult to hold the device;
ii) a baby control input area above the handle;
b) a baby control input, mounted in the baby control input area of the body, sized to be utilized by a baby to provide forward, backward, left, or right directional input;
c) a sound output device mounted within the body; and,
d) a control circuit, directly or indirectly coupled to the baby control input and the display, the control circuit arranged to indicate a desired direction via the sound output device based on the directional input from the baby control input.

2. A device comprising:
a) a body including:
i) a substantially vertical handle sized to be used by an adult to hold the device;
ii) a baby control input area above the handle;
ii) a display area on the top portion of the body proximate to the baby control input area;
b) a baby control input, mounted in the baby control input area of the body, sized to be utilized by a baby, and configured to allow at least forward, backward, left, or right directional input;
c) a display, mounted in the display area of the body; and,
d) a control circuit, directly or indirectly coupled to the baby control input and the display, the control circuit configured to indicate a desired direction on the display based on the directional input from the baby control input.

3. The device of claim 2, wherein the handle is an adult-sized pistol grip.

4. The device of claim 2, wherein the adult-sized pistol grip further includes a button to trigger a function on the device.

5. The device of claim 4, wherein the control circuit is further directly or indirectly coupled to the button and is configured indicate corrective feedback on the display when the button is used to trigger the function on the device.

6. The device of claim 2, wherein the baby control input is a baby-sized joystick.

7. The device of claim 6, wherein the baby control input includes two orthogonal potentiometers.

8. The device of claim 6, wherein the baby control input includes four switches.

9. The device of claim 6, wherein the baby control input includes a circuit that detects input in one of at least four directions.

10. The device of claim 2, wherein the display area extends at an upward and forward angle from the baby control input.

11. The device of claim 2, wherein the display includes at least four light emitting diodes associated with commands to go forward, go backward, turn left, and turn right.

12. The device of claim 2, wherein the display is an arrangement of several light emitting diodes associated with different directions or commands.

13. The device of claim 2, wherein the display is a graphic display (e.g., LCD, LED matrix, OLED, etc.) coupled to a controller and configured to display text, graphics, or symbols.

14. The device of claim 2, wherein the control circuit includes analog circuitry, digital circuitry, a microcontroller, ASIC, FPGA, or digital logic circuitry.

15. The device of claim 2, further comprising a sound output device such as a speaker or a buzzer.

16. The device of claim 15, wherein audio is reproduced or played in response to directional input received from the baby control input.

17. The device of claim 15, wherein audio is reproduced or played in response to input received via a button placed on the handle of the device.

18. A device comprising:
a) a body including:
i) a handle sized to be used by an adult to hold the device;
ii) a baby control input area above the handle;
ii) a display area on the top portion of the body proximate to the baby control input area;
b) a baby control input, mounted in the baby control input area of the body, sized to be utilized by a baby, and configured to allow at least forward, backward, left, or right directional input;
c) an adult input, mounted in the handle, and configured to allow at least a corrective feedback or positive feedback input;
d) a display including a forward LED, a backward LED, a left LED, a right LED, and an adult input LED, mounted in the display area of the body; and,
e) a control circuit, directly or indirectly coupled to the baby control input, the adult input, the display, and a speaker, the control circuit configured to indicate a desired direction on the display based on the directional input from the baby control input or illuminate the adult input LED based on the adult input, and play a corresponding sound via the speaker.
